(19) United States
(12) Patent Application Publication
(10) Pub. No.: US 2026/0291695 A1
(43) Pub. Date: Sep. 24, 2026

(54) STXMP FOR UE WITH SHARED DIGITAL PORTS

(71) Applicant: Telefonaktiebolaget LM Ericsson (publ), Stockholm (SE)

(72) Inventors: Sven JACOBSSON, Vastra Frolunda (SE); Aliakbar MIRZAEI, Lund (SE); Andreas NILSSON, Goteborg (SE); Paulo Valente KLAINE, Yokohama Kanagawa (JP)

(21) Appl. No.: 19/472,434

(22) PCT Filed: Apr. 5, 2024
(86) PCT No.: PCT/IB2024/053381

§ 371 Date: Oct. 3, 2025

Related U.S. Application Data
(60) Provisional application No. 63/457,990, filed on Apr. 7, 2023.

(51) Int. Cl. H04L 5/00; H04B 7/0404

(52) U.S. Cl. CPC H04L 5/0094; H04B 7/0404

(57) ABSTRACT

Methods and systems are described for precoding of data channel and sounding of UE panels for UE with a limited number of shared digital ports over multiple UE panels. One embodiment comprises a method performed by a UE for precoding of data channel(s) and sounding of UE panel(s). Steps can include receiving an indication in a downlink control channel that identifies an data channel transmission from one or more SRS resource sets and for which either: all SRS ports in an SRS resource set can be used for sTRP scheme or only a subset of SRS ports in an SRS resource set can be used for STxMP scheme. A further step can include transmitting an UL data channel according to the indication.

### CROSS REFERENCE TO RELATED INFORMATION

This application claims the benefit of United States of America priority application No. 63/457,990 filed on Apr. 7, 2023, titled “STxMP for UE with Shared Digital Ports.”

### TECHNICAL FIELD

The present disclosure generally relates to systems and methods for precoding of data channel and sound of UE panels.

### BACKGROUND

### Numerology

In the time domain, NR (New Radio) DL (downlink) and UL (uplink) transmissions are organized into equally sized subframes of 1 ms each. A subframe is further divided into multiple slots of equal duration. The slot length depends on the numerology (i.e., on the SCS (Subcarrier Spacing) and the CP (Cyclic Prefix)). For 15 kHz SCS, there is only one slot per subframe. In general, for 15·2^{μ} kHz SCS, where E{0,1,2,3,4} is the SCS configuration, there are 2^{μ} slots per subframe. Each slot consists of 14 symbols (unless extended CP is configured for which each slot consists of 12 symbols).

In the frequency domain, a system bandwidth is divided into RBs (Resource Blocks) each corresponding to 12 contiguous subcarriers. One subcarrier during one symbol interval forms one RE (Resource Element), which is the smallest physical resource in NR.

### Carrier Aggregation

NR (New Radio) supports CA (Carrier Aggregation) of up to 16 carriers. A UE (user equipment) capable of CA can transmit/receive on multiple carriers at the same time, where different carriers may be of different channel bandwidths. In FR1, channel bandwidths up to 100 MHz are supported. In FR2, channel bandwidths up to 400 MHz are supported.

In NR specification, a carrier is referred to as a cell. One of said cells is known as the PCell and is the cell that the UE initially connects to. After the UE is connected, one or multiple SCells can be additionally configured. Furthermore, said SCells can be dynamically (via MAC CE signaling) activated/deactivated. When CA is not configured, UE will transmit/receive only on the PCell.

The RBs within a cell (across the channel bandwidth) are known as CRBs and are numbered starting from 0. The first subcarrier in CRB 0 is known as reference point A, which is signaled to the UE as part of SIB1.

### Bandwidth Parts

NR is designed to support very large channel bandwidths (up to 400 MHz), but not all UEs are capable of handling such large channel bandwidth. For this reason, a UE can operate in a contiguous subset of the CRBs within a cell. This subset is called a BWP.

A UE can be configured with up to four DL BWPs and up to four UL BWPs per serving cell, where different numerologies can be configured for different BWPs. In the case of SUL, there can be up to four additional UL BWPs on the SUL carrier. The starting position and bandwidth of a BWP is RRC configured. Only one DL and one UL BWP can be active at the same time per serving cell. For TDD, the active DL and UL BWP must share the same center frequency. For FDD, this is not required. In the DL, a UE does not expect to receive, e.g., PDCCH and/or PDSCH outside the active BWP. In the UL, a UE is not expected to transmit, e.g., PUCCH and/or PUCCH outside of the active BWP.

The NW can switch active BWP, e.g., via DCI signaling. For example, DCI Format 1_1 (used for scheduling DL transmissions) and DCI Format 0_1 (used for scheduling UL transmissions) includes an up to 2-bit “BWP indicator” field for switching BWP for DL and UL transmissions, respectively.

The RBs within a BWP are known as PRBs and are numbered starting from 0. When the NW schedules a DL or UL transmission, a set of VRBs, which are mapped to PRBs, are signaled. In the DL, interleaved and non-interleaved mapping is supported. In the UL, only non-interleaved mapping is supported, for which there is a one-to-mapping between VRBs and CRBs. In what follows, unless otherwise stated, a one-to-one mapping can be assumed between VRBs and PRBs, and simply use RBs to refer to both VRBs and CRBs.

### PUSCH

The channel that carries data in the NR UL is called PUSCH, which can be dynamically or semi-statically scheduled. In NR, there are two possible waveforms that can be used for PUSCH: CP-OFDM and DFT-S-OFDM. The time-and-frequency domain resource allocation of said PUSCH is signaled by the NW to the UE. Furthermore, there are two transmission schemes specified for PUSCH: CB-based precoding and NCB-based precoding.

### PUSCH Scheduling

UL data transmissions can be dynamically scheduled by a DG (via DCI signaling) or semi-statically scheduled by a CG (via RRC signaling).

PUSCH scheduling with DG: PUSCH transmissions can be dynamically scheduled by sending from the NW to a UE a DG via the DCI in PDCCH. After decoding the DCI, UE transmits data (unless the transmission buffer is empty) over PUSCH according to the DG. The DG can be carried, e.g., over DCI Format 0_1 (non-fallback format) or DCI Format 0_0 (fallback format). The non-fallback format supports all NR features but is larger in size compared to the fallback format which offers limited functionality but with a smaller overhead. Contents that are common for both the non-fallback and fallback formats include, e.g., BWP indication, frequency-domain resource allocation, time-domain resource allocation, transport-block related information (MCS, NDI, and RV), and PUSCH power-control parameters. Contents that are only in the non-fallback format (DCI Format 0_1) include, e.g., multi-antenna related information.

PUSCH scheduling with CG: NR supports two schemes for scheduling PUSCH transmissions without a DG. In CG type 1, PUSCH transmission parameters, periodicity, and offset is RRC configured and PUSCH is periodically transmitted. In CG type 2, PUSCH periodicity and offset is RRC configured but PUSCH transmission is activated/deactivated using dynamic signaling. With CG type 1, PUSCH transmission parameters are RRC configured (see ConfiguredGrantConfig IE in 3GPP TS 38.331). The PUSCH periodicity and offset are also RRC configured, which allows NW to control when UE should transmit PUSCH. With CG type 2, the PUSCH periodicity and offset are RRC configured. Activation/deactivation of the PUSCH transmission is via PDCCH scrambled by CS-RNTI and PUSCH transmission parameters are signaled via DCI in said PDCCH (e.g., DCI Format 0_0 or DCI Format 0_1).

### PUSCH Precoding

For PUSCH scheduled by a DG, the NW configures in RRC the transmission scheme by the higher-layer parameter txConfig in PUSCH-Config IE (see below snippet of ASN code from 3GPP TS 38.331 version 17.2.0). Two transmission schemes are supported: CB-based precoding and NCB-based precoding. CB-based precoding can be used for non-calibrated UEs and/or for FDD (i.e., UL/DL reciprocity does not need to hold). NCB-based precoding, on the other hand, relies on UL/DL reciprocity and is, hence, intended for TDD.

PUSCH-Config IE

| | |
|---|---|
| PUSCH-Config ::= | SEQUENCE { |

...

| | |
|---|---|
| txConfig | ENUMERATED {codebook, |
| nonCodebook} | OPTIONAL, |
| codebookSubset | ENUMERATED |

{fullyAndPartialAndNonCoherent, partialAndNonCoherent,nonCoherent}
OPTIONAL,

| | |
|---|---|
| maxRank | INTEGER (1..4) |

OPTIONAL,
...
}

### CB-Based Precoding

With CB-based precoding for the NR uplink, the NW configures the UE to transmit SRS over a number of UE antennas. Based on SRS-based channel measurements, the NW signals a TPMI, which indicates the transmission rank and precoder that the UE should apply over the UE antennas when transmitting PUSCH. The precoder candidates are tabulated in Clause 6.3.1.5 of 3GPP TS 38.211.

CB-based PUSCH is enabled if the higher-layer parameter txConfig in PUSCH-Config IE is set to codebook. For dynamically scheduled PUSCH, CB-based PUSCH transmission can be summarized in the following steps.

First, the UE transmits SRS, configured in an SRS resource set with higher-layer parameter usage in SRS-Config IE set to codebook. Up to two SRS resources (for testing up to two virtualizations/beams/panels) each with up to four ports, can be configured in the SRS resource set. The gNB determines the number of layers (i.e., the rank) and a preferred precoder (i.e., TPMI) from a codebook subset based on the received SRS from one of the SRS resources. The codebook subset is configured via the higher-layer parameter codebookSubset in PUSCH-Config IE (see above snippet of ASN code from 3GPP TS 38.331 version 17.2.0), based on reported UE capability, and is one of fully coherent, partially coherent, or non-coherent.

Second, if two SRS resources are configured in the SRS resource set, the gNB indicates the selected SRS resource via the 1-bit SRI field in the DCI scheduling the PUSCH transmission. If only one SRS resource is configured in the SRS resource set, the SRI field is not present in the DCI.

Third, the gNB indicates, via the DCI field “Precoding information and number of layers”, the number of layers and the TPMI. The maximum number of layers is limited by the higher-layer parameter maxRank in PUSCH-Config IE (see above snippet of ASN code from 3GPP TS 38.331 version17.2.0). DMRS port(s) associated with the layer(s) are also indicated in DCI via the field “Antenna ports”. Unless UL full-power mode 1 is configured, the number of bits in DCI used for indicating the number of layers (if transform precoding is enabled, the number of PUSCH layers is limited to 1) and the TPMI is determined as follows:
4, 5, or 6 bits if the number of antenna ports is 4, if transform precoding is disabled, and if the higher-layer parameter maxRank in PUSCH-Config IE is set to 2, 3, or 4 (see Table 1).
2, 4, or 5 bits if the number of antenna ports is 4, if transform precoding is disabled or enabled, and if the higher-layer parameter maxRank in PUSCH-Config IE is set to 1 (see Table 2).
2 or 4 bits if the number of antenna ports is 2, if transform precoding is disabled, and if the higher-layer parameter maxRank in PUSCH-Config IE is set to 2 (see Table 3).
1 or 3 bits if the number of antenna ports is 2, if transform precoding is disabled or enabled, and if the higher-layer parameter maxRank in PUSCH-Config IE is set to 1 (see Table 4).
0 bits if 1 antenna port is used for PUSCH transmission.

Fourth, the UE performs PUSCH transmission over the antenna ports corresponding to the SRS ports in the indicated SRS resource.

FIGS. 1-4 give examples of precoding information. FIG. 1 shows precoding information and number of layers, for 4 antenna ports, if transform precoding is disabled and maxRank=2, 3 or, 4 (reproduced from Table 7.3.1.1.2-2 of 3GPP TS 38.212 version 17.2.0). FIG. 2 shows precoding information and number of layers, for 4 antenna ports, if transform precoding is disabled/enabled and maxRank=1 (reproduced from Table 7.3.1.1.2-3 of 3GPP TS 38.212 version 17.2.0). FIG. 3 shows precoding information and number of layers, for 2 antenna ports, if transform precoding is disabled and maxRank=2 (reproduced from Table 7.3.1.1.2-4 of 3GPP TS 38.212 version 17.2.0). FIG. 4 shows precoding information and number of layers, for 2 antenna ports, if transform precoding is disabled/enabled and maxRank=1 (reproduced from Table 7.3.1.1.2-5 of 3GPP TS 38.212 version 17.2.0).

### NCB-Based Precoding

NCB-based PUSCH is enabled if the higher-layer parameter txConfig in PUSCH-Config IE is set to nonCodebook and is intended for reciprocity-based UL transmission in which SRS precoding is derived at a UE based on CSI-RS received in the DL. Specifically, the UE measures received CSI-RS and deduces a suitable precoder for SRS transmission(s), resulting in one or more (virtual) SRS ports, each corresponding to a spatial layer.

A UE can be configured up to four SRS resources, each with a single (virtual) SRS port, in an SRS resource set with higher-layer parameter usage in SRS-Config IE set to nonCodebook. A UE transmits the up to four SRS resources. The NW measures the UL channel based on the received SRS, selects the preferred SRS resource(s), and indicates the selection via the SRI field in DCI. The UE uses this information to precode PUSCH with a transmission rank that equals the number of indicated SRS resources (and, hence, the number of SRS ports).

The size of the SRI field in the DCI format scheduling the PUSCH is:

$$⌈ {log}_{2} ( {\sum }_{k = 1}^{min \{ {L}_{max} , {N}_{SRS} \}} ( \begin{matrix}{N}_{SRS} \\ k\end{matrix} ) ) ⌉ bits .$$

Here, N_{SRS} is the number of SRS resources and Lₘₐₓ is maximum number of layers.

### SRS

In NR, SRS is used for providing CSI to the NW in the UL. The usage of SRS includes, e.g., deriving the appropriate transmission/reception beams and/or to perform link adaptation (i.e., setting the transmission rank and the MCS), and for determining PDSCH and PUSCH precoding matrices.

The SRS is configured via RRC signaling, where parts of the configuration can be updated (for reduced latency) via MAC CE signaling. The RRC configuration includes, for example, the SRS resource allocation (the physical mapping and the sequence to use) as well as the time-domain behavior (aperiodic, semi-persistent, or periodic). For aperiodic SRS transmission, the RRC configuration does not activate an SRS transmission from the UE but instead a dynamic activation trigger is transmitted from the NW, via the DCI in the PDCCH, which instructs the UE to transmit the SRS once, at a predetermined time.

### SRS Configuration

When configuring SRS transmissions, the gNB configures, through the SRS-Config IE, a list of SRS resources and a list of SRS resource sets (see below snippet of ASN from 3GPP TS 38.331 version 17.2.0):

SRS-Config IE

| | |
|---|---|
| SRS-Config ::= | SEQUENCE { |
| srs-ResourceSetToReleaseList | SEQUENCE (SIZE(1..maxNrofSRS-ResourceSets)) OF SRS- |

| | |
|---|---|
| ResourceSetId | OPTIONAL, |

| | |
|---|---|
| srs-ResourceSetToAddModList | SEQUENCE (SIZE(1..maxNrofSRS-ResourceSets)) OF SRS- |

| | |
|---|---|
| ResourceSet | OPTIONAL, |

| | |
|---|---|
| srs-ResourceToReleaseList | SEQUENCE (SIZE(1..maxNrofSRS-Resources)) OF SRS- |

| | |
|---|---|
| ResourceId | OPTIONAL, |

| | |
|---|---|
| srs-ResourceToAddModList | SEQUENCE (SIZE(1..maxNrofSRS-Resources)) OF SRS- |

| | |
|---|---|
| Resource | OPTIONAL, |

...
}

SRS resource(s) will be transmitted as part of an SRS resource set, where each SRS resource set contains one or more SRS resources. NR supports configuration of up to 16 SRS resource sets and 64 SRS resources per BWP. Furthermore, NR supports periodic, semi-persistent, or aperiodic SRS transmissions:
Periodic SRS (p-SRS): SRS resource sets and SRS resources are RRC configured. SRS resource configuration includes slot periodicity and offset, which determines SRS transmission occasions.
Semi-persistent SRS (sp-SRS): SRS resource sets and SRS resources are RRC configured. SRS resource configuration includes slot periodicity and offset, and SRS transmissions are activated/deactivated using MAC CE signaling.
Aperiodic SRS (ap-SRS): SRS resource sets and SRS resources are RRC configured. SRS resource-set configuration includes slot offset, and SRS transmissions are dynamically triggered via 2-bit “SRS request” field in DCI (e.g., in DCI Format 0_1 or DCI Format 1_1).

All SRS resources in an SRS resource set must share the same time-domain behavior. In short, the SRS resource-set configuration determines, e.g., SRS usage, power control parameters, and slot offset for ap-SRS. The SRS resource configuration determines, e.g., the SRS time-and-frequency allocation, the SRS sequence, the periodicity and offset for p-SRS/sp-SRS.

### SRS Resource Set Configuration

An SRS resource set is configured as shown in FIG. 5 in RRC (see ASN code in 3GPP TS 38.331 version 17.2.0). An SRS resource set is configurable with respect to various factors. For example, for ap-SRS, the slot offset is configured by the higher-layer parameter slotOffset and sets the delay from the PDCCH trigger reception to the start of the SRS transmission. The resource usage, which is configured by the higher-layer parameter usage sets constraints and assumptions on the resource properties (see 3GPP TS 38.214 for further details). SRS resource sets can be configured with one of four different usages: antennaSwitching, codebook, nonCodebook, or beamManagement. An SRS resource set that is configured with usage antennaSwitching is used for reciprocity-based DL precoding (i.e., used to sound the channel in the UL so that the gNB can use reciprocity to set a suitable DL precoders). The UE is expected to transmit one SRS port per UE antenna port. An SRS resource set that is configured with usage codebook is used for CB-based UL transmission (i.e., used to sound the different UE antennas and help the gNB to determine/signal a suitable UL precoder, transmission rank, and MCS for PUSCH transmission). There are up to two SRS resources in an SRS resource set with usage codebook. How SRS ports are mapped to UE antenna ports is, however, up to UE implementation and not known to the gNB. An SRS resource set that is configured with usage nonCodebook is used for NCB-based UL transmission. Specifically, the UE transmits one SRS resource per candidate beam (suitable candidate beams are determined by the UE based on CSI-RS measurements in the DL and, hence, reciprocity needs to hold). The gNB can then, by indicating a subset of these SRS resources, determine which UL beam(s) that the UE should apply for PUSCH transmission. One UL layer will be transmitted per indicated SRS resource. Note that how the UE maps SRS ports to antenna ports is up to UE implementation and not known to the gNB. An SRS resource set that is configured with usage beamManagement is used (mainly for frequency bands above 6 GHz (i.e., for FR2)) to evaluate different UE analog beams (e.g., panels). The UE transmits one SRS resource per analog beam, and the gNB will perform an RSRP measurement per transmitted SRS resource and, in this way, determine a suitable UE beam that is reported to the UE.

The associated CSI-RS (this configuration is only applicable for NCB-based UL transmission) can be set for each of the possible resource types. For ap-SRS, the associated CSI-RS resource is determined by the higher-layer parameter csi-RS. For p-SRS/sp-SRS, the associated CSI-RS resource is determined by the higher-layer parameter associatedCSI-RS.

The power control parameters, e.g., alpha and p0 are used for setting the SRS transmission power. SRS has its own UL power control scheme in NR (see 3GPP TS 38.213 for further details), which specifies how the UE should split the available output power between two or more SRS ports during one SRS transmit occasion (an SRS transmit occasion is a time window within a slot where SRS transmission is performed).

### SRS Resource Configuration

Each SRS resource is configured as shown in FIG. 6 in RRC (see ASN code from 3GPP TS 38.331 version 17.2.0). An SRS resource is configurable with respect to various factors. For example, the number of SRS ports (1, 2, or 4), which is configured by the higher-layer parameter nrofSRS-Ports. The transmission comb (i.e., mapping to every 2nd or 4th subcarrier), configured by the higher-layer parameter transmissionComb, which includes a comb offset and a CS. The comb offset, configured by the higher-layer parameter combOffset, is specified (i.e., which of the combs that should be used). The CS, configured by the higher-layer parameter cyclicShift, that configures a (port-specific, for multi-port SRS resources) CS for the Zadoff-Chu sequence that is used for SRS. The use of CSs allows multiplexing of SRS ports on a same comb offset, but there is a limit on how many CSs that can be used per comb offset (8 for comb 2 and 12 for comb 4).

Another variable is the time-domain position within a given slot, configured with the higher-layer parameter resourceMapping, which includes:
The time-domain start position, which is limited to be one of the last 6 symbols, configured by the higher-layer parameter startPosition.
The number of symbols for the SRS resource (that can be set to 1, 2 or 4), configured by the higher-layer parameter nrofSymbols.
The repetition factor (that can be set to 1, 2 or 4), configured by the higher-layer parameter repetitionFactor. When the repetition factor is larger than 1, the same frequency resources are used multiple times across symbols, used to improve the coverage as this allows more energy to be collected by the receiver.

Other variables are the sounding bandwidth, frequency-domain position and shift, and frequency-hopping pattern of an SRS resource (i.e., which part of the transmission bandwidth that is occupied by the SRS resource) is set through the higher-layer parameters freqDomainPosition, freqDomainShift, and the freqHopping parameters c-SRS, b-SRS, and b-hop. The smallest possible sounding bandwidth is 4 RBs. The higher-layer parameter resourceType determines whether the SRS resource is transmitted as periodic, aperiodic (singe transmission triggered by DCI), or semi persistent (same as periodic except for the start and stop of the periodic transmission is controlled through MAC-CE signaling instead of RRC signaling). The higher-layer parameter sequenceId specifies how the SRS sequence is initialized. The higher-layer parameter spatialRelationInfo configures the spatial relation for the SRS beam with respect to another RS (which could be another SRS, an SSB or a CSI-RS). If an SRS resource has a spatial relation to another SRS resource, then this SRS resource should be transmitted with the same beam (i.e., virtualization) as the indicated SRS resource.

In NR Rel-17, transmission comb 8 is supported for which the number of CSs per comb offset is 6 (see higher-layer parameter transmissionComb-n8-r17). In NR Rel-16, an SRS resource can occupy any of the 14 symbols in a slot but the number of symbols per SRS resource is limited to 4 (see higher-layer parameter resourceMapping-r16). In NR Rel-17, an SRS the number of symbols per SRS resource is up to 14 (see higher-layer parameter resourceMapping-r17).

An illustration of how an SRS resource could be allocated in time and frequency within a slot (note that semi-persistent/periodic SRS resources typically span several slots), is provided in FIG. 7 for NR Rel-15/Rel-16.

### Rel-17 Multi-TRP PUSCH Repetition

Single-DCI multi-TRP PUSCH repetition was introduced in NR Rel-17. With this scheme, a PUSCH is transmitted, in two or more different slots in a TDM fashion, to two different TRPs. Both CB-based and NCB-based operation is supported and the same number of PUSCH layers (up to four) will be transmitted in a separate beam each of the slots. To enable such PUSCH repetition, a UE can be configured with up to two SRS resource sets (with the same number of SRS resources and SRS ports) with the same usage. Here, each SRS resource set is associated with a different TRP (and, hence, a different beam). The two beams are mapped to different slots with either a cyclical mapping pattern (see FIG. 8) or a sequential mapping pattern (see FIG. 9). As the path loss to different TRPs may be significantly different, per-TRP power control can be configured (i.e., separate power control for each SRS resource set).

Dynamic switching between PUSCH single-TRP transmission and multi-TRP repetition is supported. To enable such dynamic switching, a new 2-bit “SRS resource set indicator” field is introduced in DCI format 0_1 (and DCI format 0_2). The following excerpt from 3GPP TS 38.212 describes this new field:
SRS resource set indicator—0 or 2 bits
   a. 2 bits according to Table 7.3.1.1.2-36 if
      i. txConfig=nonCodebook, and there are two SRS resource sets configured by srs-ResourceSetToAddModList and associated with the usage of value ‘nonCodebook’, or
      ii. txConfig=codebook, and there are two SRS resource sets configured by srs-ResourceSetToAddModList and associated with usage of value ‘codebook’;
   b. 0 bit otherwise.

FIG. 10 shows the codepoints (indices) of the new “SRS resource set indicator” field (a SRS resource set indication (reproduced from Table 7.3.1.1.2-36 in 3GPP TS 38.212). Here, the first two indices correspond to single PUSCH transmission to a first and second TRP (i.e., to a first and second SRS resource set) and the last two indices correspond to PUSCH repetition to both TRPs. The difference between the last two states is the mapping from, SRS resource sets to a first and a second “SRS resource indicator” field and/or a first and second “Precoding information and number of layers” field, i.e., in which order the SRS resource sets should be transmitted. The SRS resource set with lower ID is the first SRS resource set, and the other SRS resource set is the second SRS resource set.

### CB-Based Multi-TRP PUSCH Repetition

For CB-based operation, different TPMIs may be indicated for PUSCH transmission towards different TRPs. Indeed, it is unlikely that a same precoder is suitable for transmission to different TRPs.

For single-TRP PUSCH, the precoding information and number of layers is indicated via a single “Precoding information and number of layers” field in DCI.

For multi-TRP PUSCH repetition, since the number of layers towards each TRP must be the same, it is sufficient to indicate the number of layers only for one of the SRS resource sets:

For one of the SRS resource sets, the legacy “Precoding information and number of layers field” will be used.

For the other SRS resource set, it is sufficient to indicate only the precoder for a given number of layers, which reduces overhead. A new “Second precoding information” field is introduced for this purpose. The size of this field varies between 0-5 bits depending on the number of antenna ports, UE coherency, etc.

FIG. 11 shows an example the “Second precoding information” field for the case when if the number of antenna ports per PUSCH transmission is 2, if transform precoding is disabled, and if the maximum rank is set to 2 (reproduced from Table 7.3.1.1.2-4B of 3GPP TS 38.212). Note that the length of this field is 1-3 bits depending on UE coherency and the number of layers that is indicated in a first “Precoding information and number of layers field”, which is less than the 2-4 bits needed to convey both rank and precoder (cf. FIG. 3).

### NCB-Based Multi-TRP PUSCH Repetition

For NCB, different SRS resources may be indicated for PUSCH transmission towards different TRPs. For this reason, a “Second SRS resource indicator” field is added to the DCI. Since the number of layers must be the same for the second SRS resource set and for the first SRS resource set, the second SRI field may be shorter than the first SRI field. Indeed, the number of indicated SRS resources can be inferred from the first SRI field (see, e.g., Clause 7.3.1.1.2 of 3GPP TS 38.212 for the details).

Rel-18 Simultaneous Transmission from Multiple Panel (STxMP)

In NR up to Rel-17, the discussions regarding UL transmission for FR2 has mainly been for a UE with single panel transmission (transmission from a single UE panel at each time instance). In NR-Rel 18, it has been agreed to specify support for up to two simultaneously transmitting UE panels.

It has been agreed that SDM (for which different layers of a same transmission are transmitted from different panels) and SFN (for which same layers are transmitted from different panels) will be supported for single-DCI STxMP (a single DCI can schedule simultaneous transmission from both UE panels to both TRPs).

For single-DCI STxMP, it has been agreed that two SRS resource sets (one per panel) will be configured. Furthermore, it has been agreed that there will be an SRI and/or TPMI field per SRS resource set (depending on whether CB-based PUSCH or NCB-based PUSCH is configured). This holds for both SDM and SFN. For SFN, the transmission rank is conveyed only by the first SRI/TPMI field.

Furthermore, it has been agreed that dynamic switching (via the “SRS resource set indicator” field in DCI) between SDM transmission and sTRP transmission as well as between SFN transmission and sTRP transmission will be supported. This implies that UE does not know when transmitting SRS whether the SRS ports belonging to one or both SRS resource sets will be used to carry the PUSCH.

There currently exist certain challenges. The following working assumption about dynamic switching between STxMP SDM scheme and sTRP scheme is from the 3GPP RAN1#112 meeting. Working Assumption: For dynamic switching between STxMP SDM scheme and sTRP transmission, support the following:
For sTRP transmission: The maximal number of layers of sTRP transmission is configured by the maxRank (or Lₘₐₓ) as in current spec (i.e., Option 1)
For SDM scheme: configure one single maximal number of layers (separate from maxRank (or Lₘₐₓ) for sTRP) that is applied to the first SRS resource set and the second SRS resource set, separately (i.e., Alt1)
FFS: Whether/How to enable that the total number of used PUSCH antenna ports for the SDM and sTRP is the same.
Note: This corresponds to the case that digital ports are shared between the panels.
Note: RAN1 supports both implementations that digital ports are shared or separate among panels.

The FFS in the above working assumption concerns how to support UE architectures for which there is a dedicated/separate set of digital ports per UE panel (SRS resource set) and/or UE architectures for which there is a set of shared digital ports that can be redistributed between panels depending on whether sTRP or STxMP SDM transmission has been dynamically indicated.

In FIG. 12, a UE is illustrated with separate (left part of the figure) and shared (right part of the figure) digital ports. FIG. 12 shows a STxMP UE with Nₛₑₚ=4 separate digital ports per panel (left) and UE with Nₛₕ=4 shared digital ports over two panels (right). For the case when UE has 4 separate ports for each panel (up to 8 SRS ports can be active at the same time), UE may transmit PUSCH over all SRS ports belonging to one or both SRS resource sets at the same time. For the case when UE has 4 shared ports between panels (up to 4 SRS ports can be active at the same time), UE can only transmit PUSCH over at most 4 SRS ports at the same time. The shared ports can be mapped to one or multiple UE panels, and the mapping may be different at different time instants.

### SUMMARY

One embodiment under the present disclosure comprises a method performed by a UE for precoding of data channel and sound of UE panels. The method comprises receiving an indication in a downlink control channel that identifies an uplink data channel transmission from one or more SRS resource sets; and transmitting an uplink data channel according to the indication, wherein the uplink data channel is transmitted over one or more SRS ports belonging to more than one of the one or more SRS resource sets and the subset containing Mi<Ni of the Ni SRS ports in the ith SRS resource set can be dynamically indicated by a network to the UE using DCI.

Another embodiment under the present disclosure comprises a method performed by a UE for precoding of data channel and sound of UE panels. The method comprises receiving an indication in a downlink control channel that identifies an uplink sounding signal transmission of one or more configured SRS resource sets; and transmitting an uplink sounding signal according to the indication.

Another embodiment under the present disclosure comprises a method performed by a network node for configuring a UE for precoding of data channel and/or sound of UE panels. The method comprises sending an indication in a downlink control channel that identifies an uplink data channel transmission from one or more SRS resource sets; and receiving an uplink data channel according to the indication, wherein the uplink data channel is transmitted over one or more SRS ports belonging to more than one of the one or more SRS resource sets and the subset containing Mi<Ni of the Ni SRS ports in the ith SRS resource set can be dynamically indicated by a network to the UE using DCI.

Another embodiment under the present disclosure comprises a method performed by a network node for configuring or communicating with a UE for precoding of data channel and/or sound of UE panels. The method comprises sending an indication in a downlink control channel that identifies an uplink sounding signal transmission of one or more configured SRS resource sets; and receiving an uplink sounding signal according to the indication.

This summary is provided to introduce a selection of concepts in a simplified form that are further described below in the detailed description. This summary is not intended to identify key features or essential features of the claimed subject matter, nor is it intended to be used as an indication of the scope of the claimed subject matter.

### BRIEF DESCRIPTION OF THE DRAWINGS

For a more complete understanding of the present disclosure, reference is now made to the following descriptions taken in conjunction with the accompanying drawings, in which:

FIG. 1 illustrates a table of precoding information and number of layers, for 4 antenna ports, if transform precoding is disabled and maxRank=2, 3 or, 4;

FIG. 2 illustrates a table of precoding information and number of layers, for 4 antenna ports, if transform precoding is disabled/enabled and maxRank=1;

FIG. 3 illustrates a table of precoding information and number of layers, for 2 antenna ports, if transform precoding is disabled and maxRank=2;

FIG. 4 illustrates a table of precoding information and number of layers, for 2 antenna ports, if transform precoding is disabled/enabled and maxRank=1;

FIGS. 5A-5B illustrate an example of how an SRS resource set is configured in RRC;

FIG. 6A-6B illustrate an example of how an SRS resource set is configured in RRC;

FIG. 7 illustrates an example of how an SRS resource could be allocated in time and frequency within a slot in NR Rel-15/Rel-16;

FIG. 8 illustrates a PUSCH multi-TRP repetition with cyclic mapping pattern;

FIG. 9 illustrates PUSCH multi-TRP repetition with sequential mapping pattern;

FIG. 10 illustrates a table of SRS resource set indication;

FIG. 11 illustrates a table of second precoding information and number of layers, for 2 antenna ports, if transform precoding is disabled and maxRank=2;

FIG. 12 illustrates an STxMP UE with Nsep=4 separate digital ports per panel and UE with Nsh=4 shared digital ports over two panels;

FIG. 13 illustrates a flow chart of a method embodiment under the present disclosure;

FIG. 14 illustrates a flow chart of a method embodiment under the present disclosure;

FIG. 15 illustrates a UE with two four-port panels (each consisting of a pair of two-port subarrays) located at left and right side of UE, two SRS resource sets are mapped to different panels;

FIG. 16 illustrates a UE with four two-port panels located at left, top, right, and bottom side of UE, two SRS resource sets are mapped to different pairs of panels;

FIG. 17 illustrates an example of mapping between PUSCH layers (and associated DMRS ports) to SRS resource sets and mapping between SRS resource sets and UE panels;

FIG. 18 illustrates an example of a UE transmitting over all 4 SRS ports belonging to SRS resource set 1, greyed out/dashed lines indicate that SRS ports are not carrying PUSCH;

FIG. 19 illustrates an example UE transmitting over 2 SRS ports from each of SRS resource set 1 and SRS resource set 2, greyed out/dashed lines indicate that SRS ports are not carrying PUSCH;

FIG. 20 illustrates a table of SRI indication for non-codebook based PUSCH transmission;

FIG. 21 illustrates a flow chart of a method embodiment under the present disclosure;

FIG. 22 illustrates a flow chart of a method embodiment under the present disclosure;

FIG. 23 shows a schematic of a communication system embodiment under the present disclosure;

FIG. 24 shows a schematic of a user equipment embodiment under the present disclosure;

FIG. 25 shows a schematic of a network node embodiment under the present disclosure;

FIG. 26 shows a schematic of a host embodiment under the present disclosure;

FIG. 27 shows a schematic of a virtualization environment embodiment under the present disclosure; and

FIG. 28 shows a schematic representation of an embodiment of communication amongst nodes, hosts, and user equipment under the present disclosure.

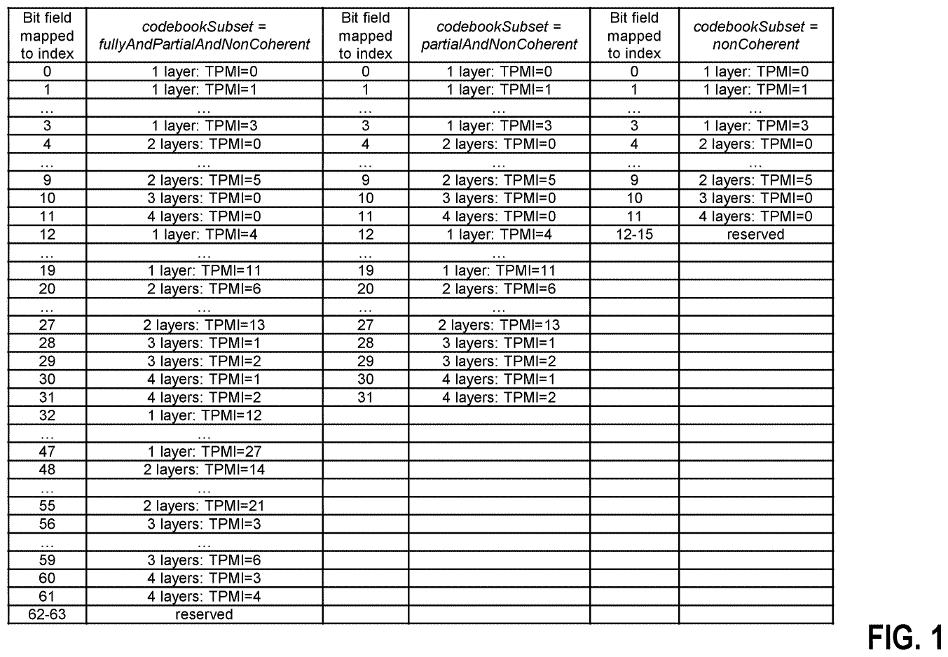

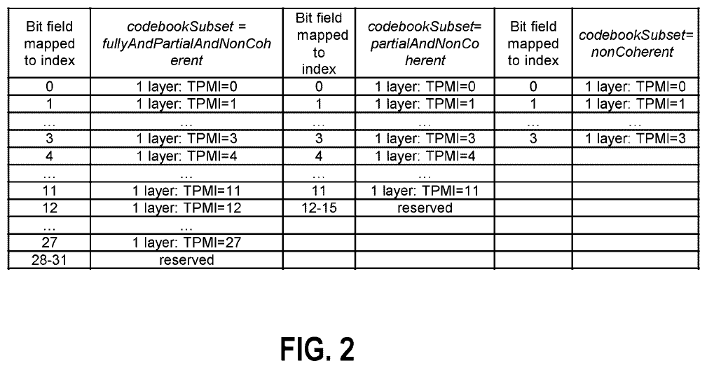

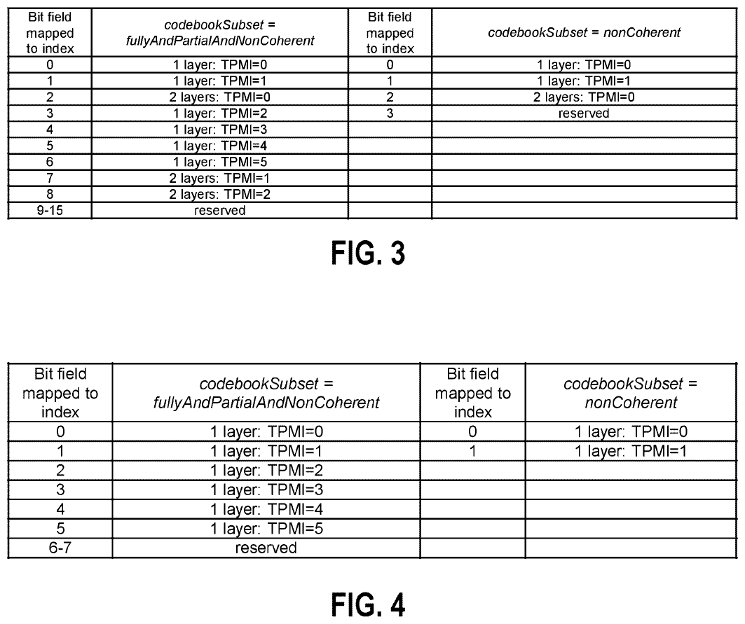

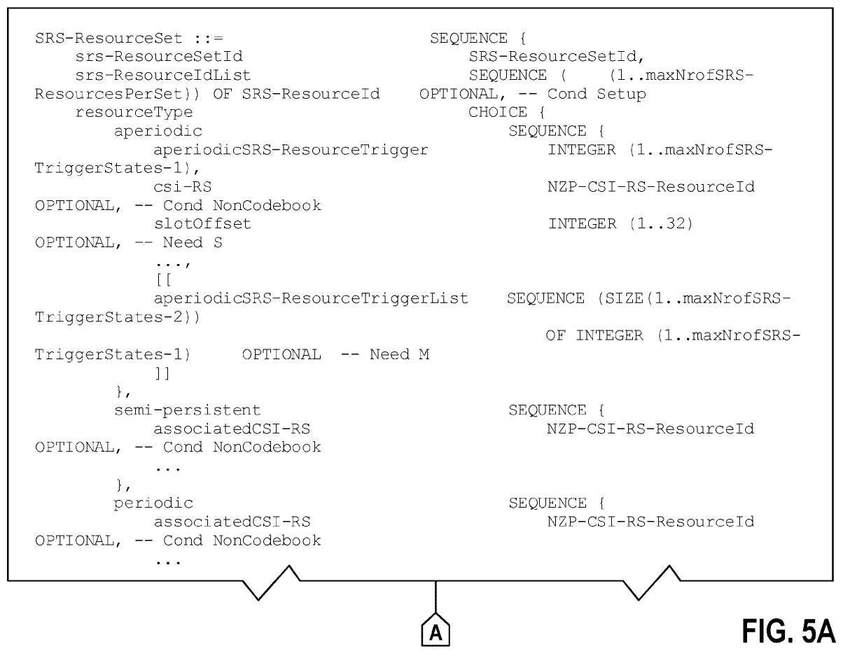

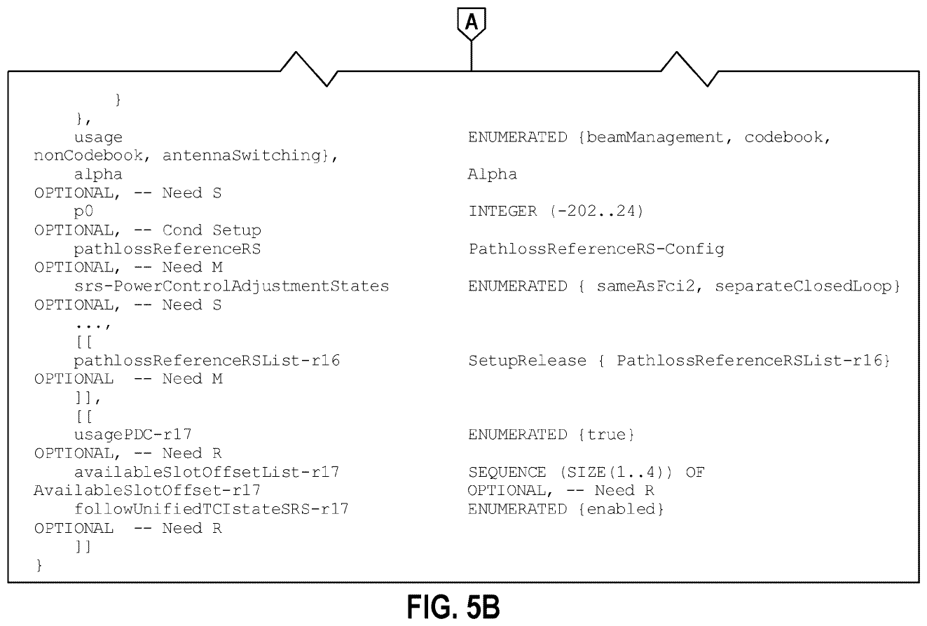

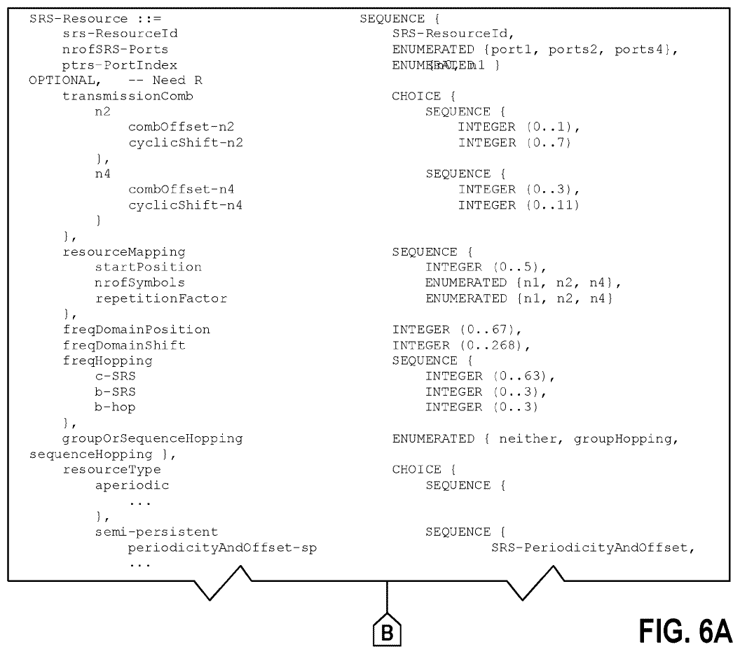

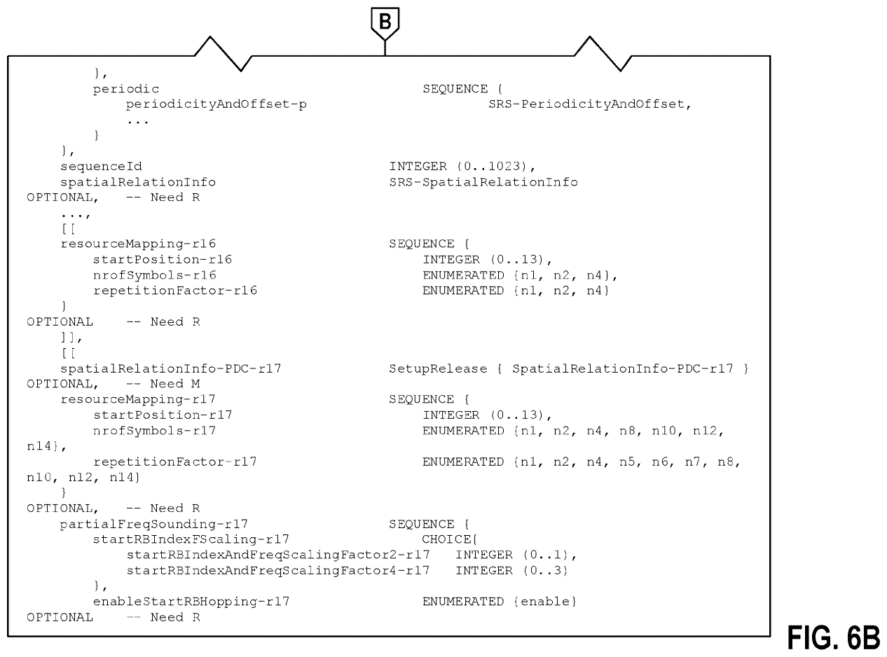

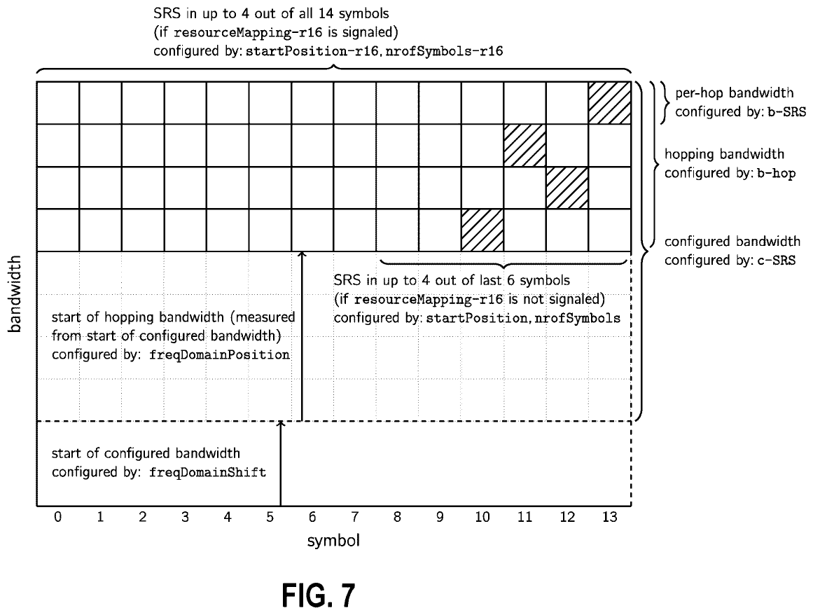

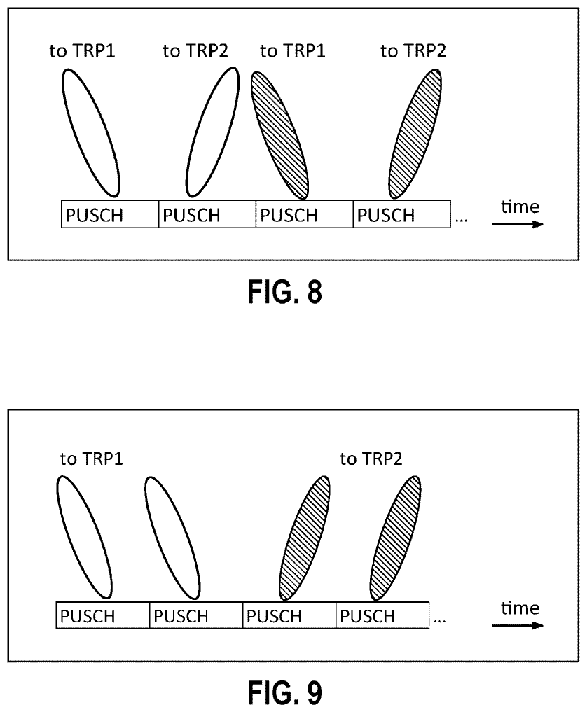

### DETAILED DESCRIPTION

Before describing various embodiments of the present disclosure in detail, it is to be understood that this disclosure is not limited to the parameters of the particularly exemplified systems, methods, apparatus, products, processes, and/or kits, which may, of course, vary. Thus, while certain embodiments of the present disclosure will be described in detail, with reference to specific configurations, parameters, components, elements, etc., the descriptions are illustrative and are not to be construed as limiting the scope of the claimed embodiments. In addition, the terminology used herein is for the purpose of describing the embodiments and is not necessarily intended to limit the scope of the claimed embodiments. In what follows, the term “STxMP UE” is used to refer to a UE that is capable of UL transmission over multiple SRS resource sets (e.g., mapped to different UE panels) at a same transmission occasion (i.e., in a same OFDM symbol). Furthermore, “STxMP scheme” can refer to either of STxMP SDM scheme or STxMP SFN scheme. Also, in what follows, up to two SRS resource sets and up to four SRS ports per SRS resource set are considered (same as what has been in NR Rel-18). However, embodiments disclosed in the following can be extended/generalized to more than two SRS resource sets and more than four SRS ports per SRS resource set.

There currently exist certain challenges in the prior art, as described above. As explained further below, precoding indication for STxMP SDM (and SFN) scheme for a UE with shared digital ports requires special consideration/solution compared to UEs with separate ports per panel.

Certain aspects of the disclosure and their embodiments may provide solutions to these or other challenges. Embodiments under the present disclosure include methods for precoding of data channel and sounding of UE panels for UE with a limited number of shared digital ports over multiple UE panels.

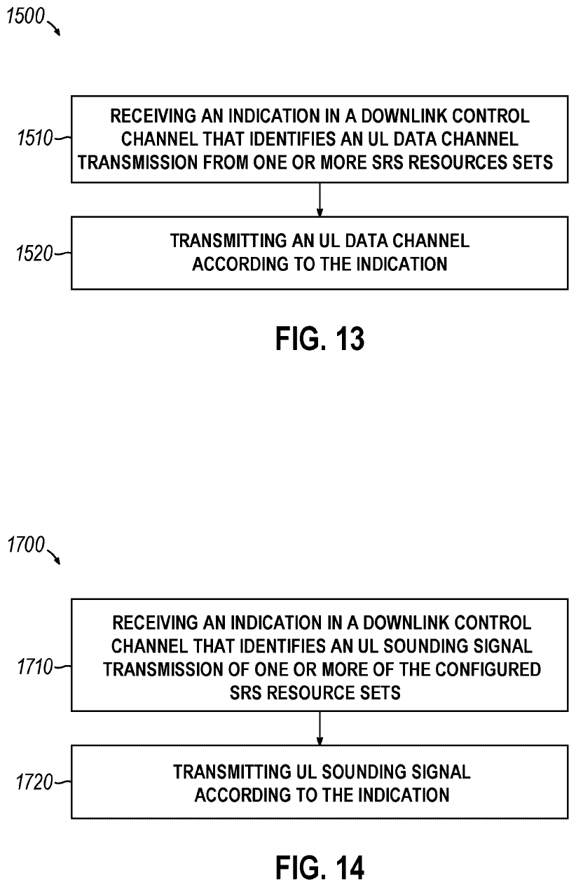

Certain embodiments under the present disclosure include various methods and systems. One embodiment, shown in FIG. 13, comprises a method 1500 perform by a UE for precoding of data channel(s) and sounding of UE panel(s). Step 1510 is receiving an indication in a downlink control channel that identifies an UL data channel transmission from one or more SRS resource sets. The SRS resource sets can be characterized in that for which either:
(All SRS ports in an SRS resource set can be used for sTRP scheme) If transmission from only one SRS resource set is indicated, up to all of Nᵢ SRS ports in the ith SRS resource set can be active (i.e., one or more PUSCH layer(s) is mapped to said port) in a same OFDM symbol.
(Only a subset of SRS ports in an SRS resource set can be used for STxMP scheme) If transmission from more than one SRS resource set is indicated, only a subset containing Mi<Nᵢ of the Nᵢ SRS ports in the ith SRS resource set can be active (i.e., one or more PUSCH layer(s) is mapped to said port) in a same OFDM symbol.

Step 1520 is transmitting an UL data channel according to the indication. For example, the UL data channel can be characterized in that it is transmitted over a subset of SRS ports belonging to one or more of the SRS resource sets and wherein the subset is either all of the Nᵢ SRS ports of one SRS resource set, if a single SRS resource set is indicated, or includes at most Mi<Nᵢ of the SRS ports from the ith SRS resource set, if, multiple SRS resource sets are indicated. In some embodiments Method 1500 can be performed by a UE capable of transmitting simultaneously over SRS ports associated with a plurality of SRS resource sets, where different SRS resource sets are mapped to different subsets of UE antenna ports (different UE panels). PUSCH can be transmitted from all ports belonging to a same panel or from only a subset of ports belonging to different panels at the same time. Method 1500 can comprise multiple variations and embodiments and/or additional and/or alternative steps.

Another embodiment, shown in FIG. 14, comprises a method 1700 perform by a UE for precoding of data channel(s) and sounding of UE panel(s). In method 1700, SRS can be transmitted from all of the ports belonging to a same panel at the same time, but SRS cannot be transmitted from different panels at the same time. Step 1710 is receiving an indication a downlink control channel that identifies an UL sounding signal transmission of one or more of the configured SRS resource sets and for which either:
(All SRS ports in an SRS resource set can be sounded at the same time) Up to all of the Nᵢ SRS ports belonging to the ith SRS resource set can be sounded/transmitted in a same OFDM symbol.
(SRS ports from more than one SRS resource set cannot be sounded at the same time) None of the Nⱼ SRS ports belonging to the jth SRS resource set, where j≠i, can be sounded/transmitted in an OFDM symbol where one or more of Nᵢ SRS ports belonging to the ith SRS resource set are sounded/transmitted. Step 1720 is transmitting UL sounding signal according to the indication. Method 1700 can comprise multiple variations and embodiments and/or additional and/or alternative steps.

Methods 1500 and 1700 can comprise a variety of additional or alternative steps.

In one example (the subset of ports per panel is not fixed for STxMP scheme), method 1500 can be implemented such that the UL data channel is transmitted over the SRS ports belonging to more than one SRS resource set and the subset containing Mi<Nᵢ of the Nᵢ SRS ports in the ith SRS resource set can be dynamically indicated by the NW to the UE using DCI.

In another example (wherein UE support only NC precoders for STxMP scheme but may additionally support PC and FC precoders for sTRP scheme) method 1500 or 1700 can be implemented such that, for CB-based operation, the subset of ports and precoder for each SRS resource set is indicated by the NW to the UE via a TPMI field in DCI and wherein the set A of valid precoder candidates in said TPMI field is a subset of the set B of valid precoder candidates for the case when UL data channel is transmitted over the SRS ports belonging to one SRS resource set.

In another example (wherein PC UE must use NC precoders for STxMP scheme) A is the set of NC precoders and B is the set of NC+PC precoders for Nᵢ ports, respectively. In some variations (wherein PC UE can use NC+PC precoders for STxMP scheme, but only for rank 1) the number of SRS ports and indicated rank for the ith SRS resource set is 4 and 1 respectively, for which A is the set of NC+PC precoders (for rank >1, A is still the set of NC precoders.

In another variation, for example wherein FC UE must use NC+PC precoders for STxP scheme, A can comprise the set of NC precoders and B is the set of NC+PC+FC precoders for Nᵢ ports, respectively. In a similar variation, wherein FC UE can use NC+PC precoders for STxMP scheme, but only for rank 1, the number of SRS ports and indicated rank for the ith SRS resource set is 4 and 1 respectively, for which A is the set of NC+PC precoders (for rank >1, A is still the set of NC precoders).

In other possible variations, such as using a new codebook for SDM scheme, the subset of ports and precoder for each SRS resource set is indicated by the NW to the UE for CB-based operation via a TPMI field in DCI and the CB (the set of precoder candidates) is different compared to the case when UL data channel is transmitted over the SRS ports belonging to one SRS resource set.

In another variation, such as wherein the subset of ports per panel is fixed for STxMP scheme, the UL data channel is transmitted over the SRS ports belonging to more than one SRS resource set and the subset containing Mᵢ<Nᵢ of the Nᵢ SRS ports is fixed and known to both the UE and the NW.

In another variation, such as wherein the subset of ports is different polarizations of same antenna element, for Nᵢ=4, the subset of SRS ports is the first and third SRS port in the SRS resource set. In another variation, such as wherein the subset of ports is same polarization of different antenna element, for Nᵢ=4, the subset of SRS ports is the first and second SRS port in the SRS resource set.

In other variations, such as wherein there is a fixed subset of SRS resources for NCB-based STxMP scheme, for NCB-based precoding the NW can indicate to the UE via an SRI field in DCI only Mᵢ<Nᵢ of the Nᵢ SRS resources in the ith SRS resource set.

In some possible variations, such as wherein the size of SRI field is different for sTRP and STxMP schemes, N_{SRS}=Mᵢ can be used to determine the size of the SRI field for the ith SRS resource set for the case when the UL data channel is transmitted over the SRS ports belonging to more than one SRS resource set and N_{SRS}=Nᵢ is used to determine the size of the SRI field for the ith SRS resource set for the case when UL data channel is transmitted over the SRS ports belonging to only one SRS resource set.

In certain other possible variations, such as wherein there exists a restriction on valid SRI codepoints, N_{SRS}=Nᵢ can be used to determine the size of the SRI field for the ith SRS resource set for the case when the UL data channel is transmitted over the SRS ports belonging to more than one SRS resource set but NW can indicate to the UE only a subset of the codepoints in said SRI field.

In other embodiments, such as wherein the size of TPMI field is different for sTRP and STxMP schemes, for CB-based precoding the NW can indicate to the UE via a TPMI field in DCI a Mᵢ-port precoder for the ith SRS resource set for the case when the UL data channel is transmitted over the SRS ports belonging to more than one SRS resource set and a Nᵢ-port precoder for the ith SRS resource set for the case when the UL data channel is transmitted over the SRS ports belonging to only one SRS resource set.

In certain embodiments, such as with a restriction on valid TPMI codepoints, for CB-based precoding the NW can indicate to the UE via a TPMI field in DCI a Nᵢ-port precoder for the ith SRS resource set for the case when the UL data channel is transmitted over the SRS ports belonging to more than one SRS resource set but NW can indicate to the UE only a subset of the codepoints in said SRI field.

In other embodiments, such as wherein the UE indicates whether digital ports are shared or separate, the UE explicitly indicates via UE capability signaling whether digital ports are shared or separate between panels.

In other embodiments, such as wherein the UE signals separate coherence capability for sTRP and STxMP schemes, for CB-based precoding wherein UE indicates via UE capability signaling a first UE coherency capability for the case when the UL data channel is transmitted over the SRS ports belonging to more than one SRS resource set and a second UE coherency capability for the case when the UL data channel is transmitted over the SRS ports belonging to only one SRS resource set.

In other variations, such as wherein the UE signals support for sounding multiple SRS resource sets at the same time, the UE indicates whether more than one SRS resource set with usage ‘codebook’ and/or ‘nonCodebook’ can be transmitted at the same time. In case the UE does not have shared digital ports between panels, both Nᵢ and Nⱼ SRS ports belonging to the ith and jth SRS resource sets, respectively can be sounded/transmitted in the same OFDM symbol.

Certain embodiments may provide one or more of the following technical advantages. With certain embodiments, the NW can configure precoding and sound channel for UE with shared digital ports in such a way that the number of SRS ports which carry PUSCH does not exceed UE capability. Furthermore, proposed UE capability signaling allows the NW to distinguish whether UE has shared or separate digital ports, which ensures that UE can be configured with suitable precoder/channel sounding for each case.

Some of the embodiments contemplated herein will now be described more fully with reference to the accompanying drawings. Embodiments are provided by way of example to convey the scope of the subject matter to those skilled in the art.

UE with Shared/Separate Ports Between Panels

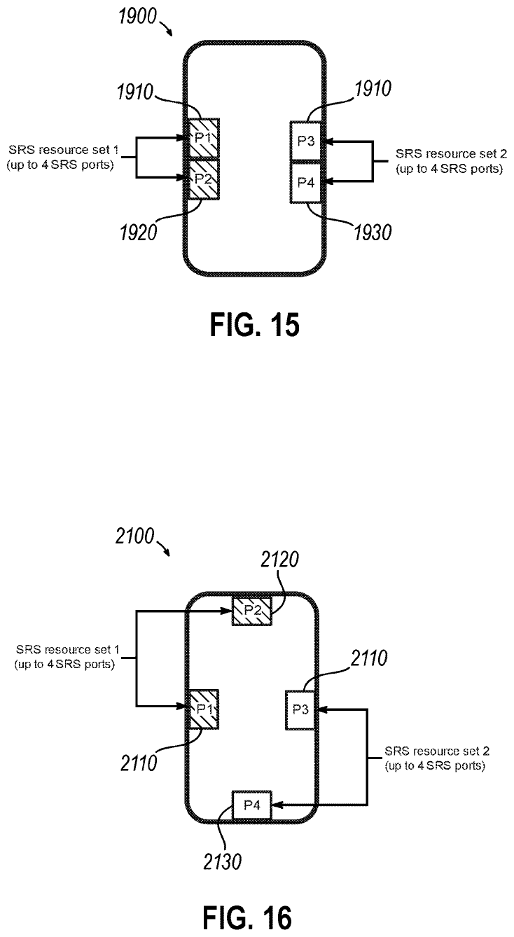

The mapping between SRS resource sets to UE panels is up to the UE and transparent to the NW. In FIG. 15 and FIG. 16, two examples are provided of how such a mapping could look like, at a given moment in time, for a UE 1900, 2100 with two four-port panels (FIG. 15) and four two-port panels (FIG. 16). In the figures, each (sub-)array P1, . . . , P4 has two antenna ports such that the number of SRS ports per SRS resource set is four. FIG. 15 shows a UE 1900 with two four-port panels 1910 (each consisting of a pair of two-port subarrays) located at left and right side of UE 1900. Two SRS resource sets 1920, 1930 are mapped to different panels 1910. FIG. 16 shows a UE 2100 with four two-port panels 2110 located at left, top, right, and bottom side of UE 2100. Two SRS resource sets 2120, 2130 are mapped to different pairs of panels 2110.

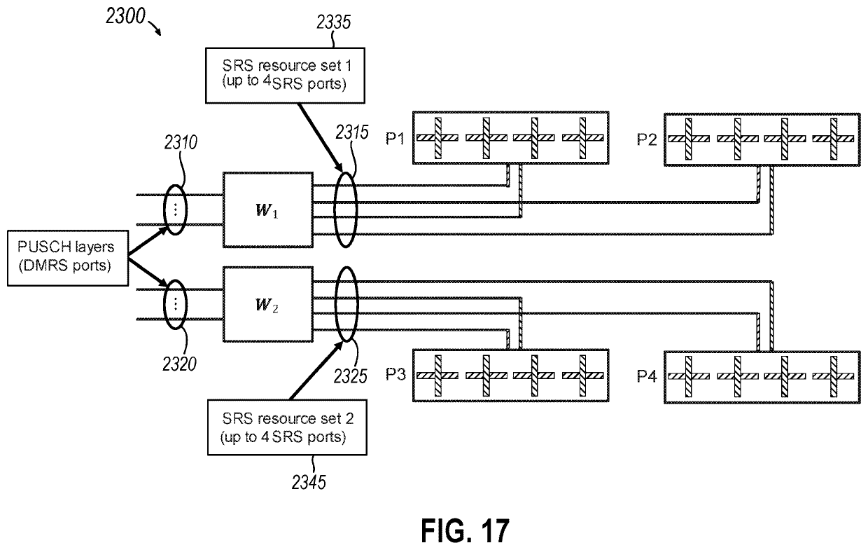

FIG. 17 shows an embodiment of the mapping 2300 from PUSCH layers 2310, 2320 (with DMRS ports) to two four-port SRS resource sets 2335, 2345 mapped to different SRS ports 2315, 2325, and UE (sub-)arrays P1, P2, P3, P4. In this example, each (sub-)array P1, . . . , P4 has four dual-polarized antenna elements and two antenna ports (one per polarization). Here, W₁ indicates the UE precoder for the first SRS resource set 2335 and W₂ indicates the UE precoder for the second SRS resource set 2345. FIG. 17 shows both an example of mapping between PUSCH layers 2310, 2320 (and associated DMRS ports 2315, 2325) to SRS resource sets 2335, 2345 and mapping between SRS resource sets 2335, 2345 and UE panels with (sub-)arrays P1 . . . P4.

For a PUSCH transmission from a UE with four separate/dedicated digital ports for each of the two SRS resource sets, precoding indication becomes relatively simple: The precoder for the first SRS resource set does not depend on the precoder for the second SRS resource set and both precoders can be fully connected (i.e., PUSCH layers can be mapped to all SRS ports over the two SRS resource sets).

For a PUSCH transmission from a UE with four digital ports that are shared over two SRS resource sets, on the other hand, the following conditions should hold.

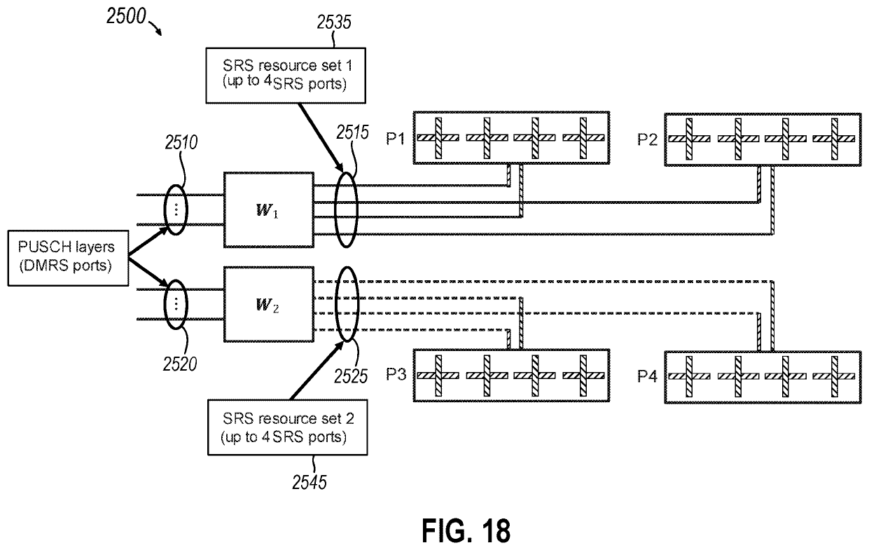

For sTRP scheme (an example is provided in FIG. 18): Up to four PUSCH layers 2510, 2520 (with DMRS ports) are mapped to up to four SRS ports 2515, 2525 (where the number of SRS ports is greater than or equal to the number of PUSCH layers) belonging to a same SRS resource set 2535, 2545 (i.e., only one of the two SRS resource sets configured for the UE). FIG. 18 shows an example where a UE transmits over all four SRS ports 2515 belonging to SRS resource set 1 2535. Here, the greyed out/dashed lines indicate that SRS ports 2525 are not carrying PUSCH. W1 and W2 are precoders.

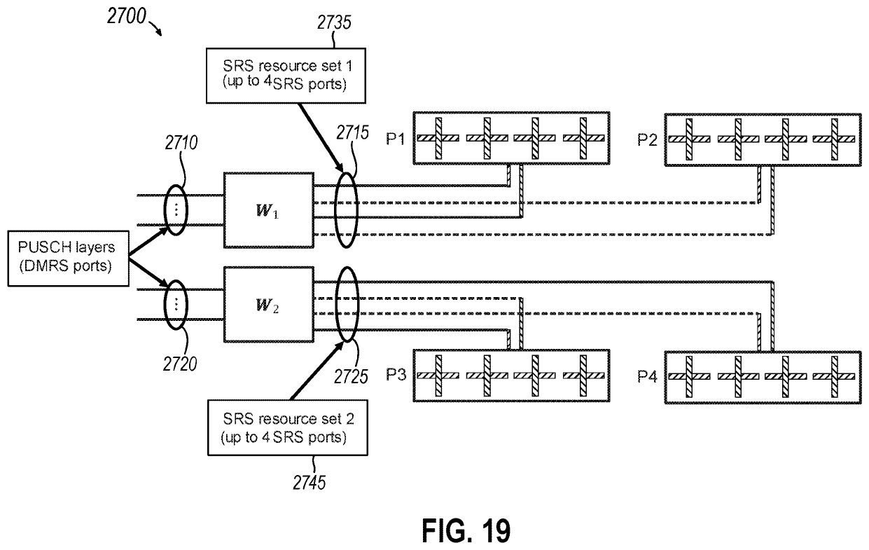

For STxMP scheme (an example is provided in FIG. 19): Up to four PUSCH layers 2710, 2720 (with DMRS ports) are mapped to up to four SRS ports 2715, 2725 (where the number of SRS ports is greater than or equal to the number of PUSCH layers) over two SRS resource sets 2735, 2745 (i.e., both SRS resource sets configured for the UE). At most two PUSCH layers are mapped to at most two SRS ports 2715, 2725 per SRS resource set 2735, 2745 (i.e., at least two SRS ports per SRS resource sets do not carry PUSCH layers). In FIG. 19 the UE transmits over two SRS ports 2715, 2725 from each of SRS resource set 1 2735 and SRS resource set 2 2745. Here, the greyed out/dashed lines indicate which SRS ports are not carrying PUSCH.

A trivial solution that would enable CB-based STxMP scheme for a UE with shared digital ports is that STxMP UE reports NC capability such that the precoder candidates are limited to antenna-selection precoders. For example, for CB-based STxMP scheme, UE with shared digital ports may receive indication to use the following two precoders (corresponding to TPMI index 1 and 2 in Table 6.3.1.5-5 in 3GPP TS 38.211):

$${W}_{1} = [ \begin{matrix}1 & 0 \\ 0 & 0 \\ 0 & 1 \\ 0 & 0\end{matrix} ]$$

$${W}_{2} = [ \begin{matrix}1 & 0 \\ 0 & 0 \\ 0 & 0 \\ 0 & 1\end{matrix} ]$$

Note that with the above choice of W₁ and W₂, four PUSCH layers are mapped to only four SRS ports over the two SRS resource sets, which adheres to the above conditions. However, it can be shown that this trivial solution can result in significantly degraded performance (compared to embodiments under the present disclosure). This performance degradation is because UE would have to use NC precoder also for sTRP scheme even if it supports NC+PC or NC+PC+FC precoders. Hence, trivial solution results in loss in precoding gain for sTRP scheme. And also because a UE that supports up to two layers per SRS resource set for STxMP scheme would have to use NC precoder even if configured with rank 1, for which a PC precoder would also satisfy the above conditions. Hence, trivial solution results in loss in precoding gain for STxMP scheme.

### UL Transmission/Precoding

Certain embodiments can comprise UL Transmission/Precoding over a subset of SRS ports per SRS resource for STxMP SDM and/or SFM scheme but not for sTRP scheme. In one embodiment, for CB-based transmission, a UE with shared digital ports can be configured with a different/smaller subset of precoders for an STxMP transmission (i.e., over more than one SRS resource set) compared to an sTRP transmission (i.e., over one SRS resource set).

In one embodiment, a FC UE (i.e., a UE that has signaled support for the NC+PC+FC subset of precoders) that is configured to transmit PUSCH over a single SRS resource set can map PUSCH layers to up to all SRS ports belonging to the single SRS resource set using FC, PC, or NC precoders. However, when switching to STxMP via the “SRS resource set indicator” field in DCI, there are two possibilities that can happen, depending on the whether the UE indicates its digital ports are shared or separate. If the UE has separate ports per panel, it can utilize all FC+PC+NC precoders. On the other hand, if the UE has shared ports between panels, then the UE is limited to using NC (and, possibly, PC, depending on rank) precoders. For example, in case the UE has four shared ports and is configured with STxMP transmission with two layers from an SRS resource set, only NC precoders can be selected for said SRS resource set, since such precoders map up to two PUSCH layers to up to two SRS ports, and, hence, the number of SRS ports over two SRS resource sets cannot exceed four, which in this example corresponds to the number of shared digital ports. In one embodiment, in case the UE has four shared ports and is configured with STxMP transmission with 1 layer from an SRS resource set only NC+PC precoders can be selected for said SRS resource set, since such precoders map 1 PUSCH layer to up to two SRS ports, and, hence, the number of SRS ports over two SRS resource sets cannot exceed four, which in this example corresponds to the number of shared digital ports. In one alternate embodiment, in case the UE has four shared ports and is configured with STxMP transmission, it must use NC precoders irrespectively of the rank.

In another embodiment, a PC UE (i.e., a UE that has signaled support for the NC+PC subset of precoders) that is configured to transmit PUSCH over a single SRS resource set can map PUSCH layers to up to all SRS ports belonging to the single SRS resource set using PC or NC precoders. However, when switching to STxMP via the “SRS resource set indicator” field in DCI, there are two possibilities that can happen, depending on the whether the UE indicates its digital ports are shared or separate. If the UE has separate ports per panel, it can utilize all PC+NC precoders. On the other hand, if the UE has shared ports between panels, then the UE is limited to using NC (and, possibly, PC, depending on rank) precoders. For example, in case the UE has four shared ports and is configured with STxMP transmission with two layers from an SRS resource set, only NC precoders can be selected for said SRS resource set, since such precoders map up to two PUSCH layers to up to two SRS ports, and, hence, the number of SRS ports over two SRS resource sets cannot exceed four, which in this example corresponds to the number of shared digital ports. In one embodiment, in case the UE has four shared ports and is configured with STxMP transmission with one layer from an SRS resource set only NC+PC precoders can be selected for said SRS resource set, since such precoders map one PUSCH layer to up to two SRS ports, and, hence, the number of SRS ports over two SRS resource sets cannot exceed four, which in this example corresponds to the number of shared digital ports. In one alternate embodiment, in case the UE has four shared ports and is configured with STxMP transmission, it must use NC precoders irrespectively of the rank.

In one embodiment, for CB-based transmission the UE can be configured with a different/new codebook of precoders for an STxMP transmission (i.e., over more than one SRS resource set) compared legacy codebook, which is used for sTRP transmission (i.e., over one SRS resource set).

In one embodiment, a UE with shared digital ports that has received indication to perform an STxMP transmission (i.e., over more than one SRS resource set) will map PUSCH layers via an indicated M-port precoder to a (fixed and known to both UE and NW) subset of the N>M SRS ports in at least one of more than one SRS resource set. If the same UE has received indication to perform an sTRP transmission (i.e., over one SRS resource set), it will map PUSCH layers via an indicated precoder to all N SRS ports in the indicated SRS resource set.

In one embodiment, for a 4-port SRS resource set in a collection of more than one SRS resource sets over which a STxMP transmission has been indicated, a 2-port precoder is mapped to two of the four SRS ports in said set.

In one embodiment, the 2-port precoder is mapped to the 2 SRS ports in the SRS resource set that has the lowest port index.

In an alternate embodiment, the 2-port precoder is mapped to the lowest and third lowest port index in the SRS resource set. In this case, in a related embodiment, a UE with shared ports that support four Tx PC precoders for the sTRP case can be implicitly understood to support two Tx FC precoders for the STxMP case. The reason for this is that the first and third (and second and fourth) SRS port are assumed to be mutually coherent for a 4-port partially coherent precoder. Hence, they can be assumed to be coherent also for a 2-port fully coherent precoder mapped to the first and third SRS port.

In one embodiment, for NCB-based precoding, a UE with shared digital ports that has received indication to perform an STxMP transmission (i.e., over more than one SRS resource set) will map PUSCH layers via a (fixed and known to the UE and NW) subset of size M of SRS resources out of a total of N>M SRS resources in at least one of more than one SRS resource set. If the same UE has received indication to perform an sTRP transmission (i.e., over one SRS resource set), it will map PUSCH layers via an indicated precoder to up to all N SRS resources in the indicated SRS resource set.

In one embodiment, for NCB-based precoding, the size of the corresponding SRI field in DCI will be computed assuming N_{SRS}=M SRS resources when STxMP transmission is indicated and assuming N_{SRS}=N SRS resources when sTRP transmission is indicated.

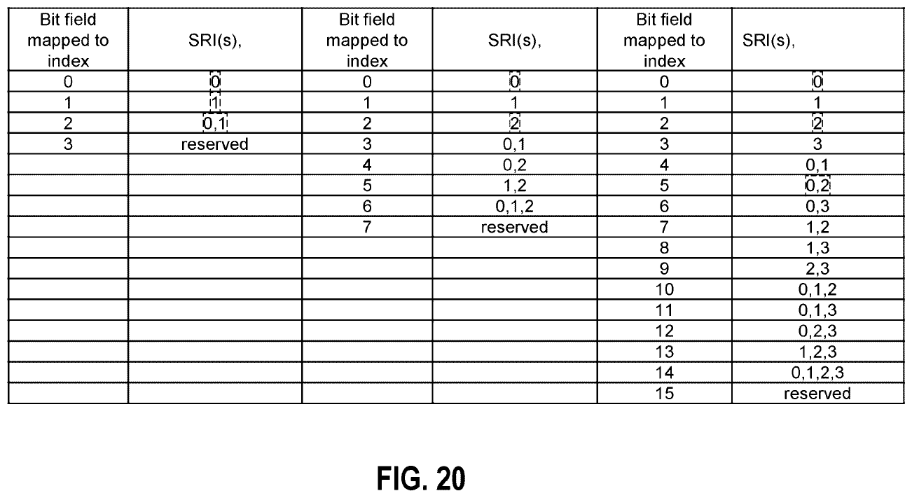

In one embodiment, for NCB-based precoding, the size of the corresponding SRI field in DCI will be computed assuming N_{SRS}=N SRS resources irrespectively of whether STxMP or sTRP transmission is indicated. However, when STxMP is indicated, only a subset of codepoints in the SRI field are supported. An example is provided in FIG. 20 for the case N_{SRS}=N=2,3,4 and for UE with four shared digital ports that shall perform STxMP transmission over two SRS resource sets with N_{SRS}=N=2,3,4 single-port SRS resources each. FIG. 20 shows SRI indication for non-codebook based PUSCH transmission (reproduced from Table 7.3.1.1.2-32 in 3GPP TS 38.212).

### Simultaneous UE Capability Signaling and UL Sounding

Some embodiments can comprise UE capability signaling and UL sounding from single/multiple SRS resource sets at the same time. In one embodiment, STxMP UE may indicate capability that SRS ports belonging to a plurality of SRS resource sets with usage ‘codebook’ or ‘nonCodebook’ can (or cannot) be transmitted at the same time. Based on above UE capability signaling, NW can infer whether STxMP UE has shared digital ports between panels or not.

In one embodiment, UE signals new UE coherency capability for STxMP SDM and/or SFN scheme that can be different from legacy UE coherency capability. In this case, the legacy UE coherency capability will be used to determine a (sub)set of precoders for sTRP transmission over single SRS resource set whereas the new UE coherency capability will determine a (sub)set of precoders for STxMP transmission over multiple SRS resource sets.

In one embodiment, irrespective of UE coherency capability (e.g., UE has signaled support for FC precoders), UE can use only NC precoders (for both sTRP and STxMP scheme) if configured with two SRS resource sets and with SDM/SFN scheme.

In one embodiment the UE signals support for STxMP during UE capability signaling, and where the UE capability message that indicates support for STxMP contains one or more of the following indications (in one embodiment, one or more of the bullets listed below belongs to a separate UE capability message than the UE capability message indicating support for STxMP, however where the bullets are still associated with STxMP operation):
Maximum number of supported SRS resource sets for STxMP (this could be useful in case STxMP is supported for more than two UE panels in future NR releases or 6G, and the UE should indicate the maximum number of panels (i.e., SRS resource sets) that can be used for STxMP).
Maximum number of simultaneously transmitted SRS ports across all SRS resource sets used for STxMP. This capability is used to indicate the maximum number of SRS ports used for STxMP that the UE can transmit simultaneously (i.e., in the same symbol). Assume that a UE reports that the “Maximum number of simultaneously transmitted SRS ports across all SRS resource sets used for STxMP” is equal to 4. In this case, if the UE is configured with two SRS resource sets for STxMP (for example two SRS resource sets with usage ‘codebook’) and where each SRS resource set consists of one two-port SRS resource, then the UE can transmit both SRS resource sets in the same OFDM symbol, since the total number of SRS ports in the two sets are equal to four. However, in case the UE is configured with two SRS resource sets for STxMP where each SRS resource set consists of one four-port SRS resource, then, the UE only can transmit one SRS resource set per OFDM symbol (i.e., the transmission of the two SRS resource sets needs to be transmitted in non-overlapping time instances). Please note that this capability could be used to implicitly indicate if the UE has shared digital ports across UE panels, or if the UE has separate digital ports per UE panel. For example, with reference to FIG. 4, the left case with separate digital ports per UE panel could report a “Maximum number of simultaneously transmitted SRS ports across all SRS resource sets used for STxMP” equal to 8, while the right case with shared digital ports across UE panels only can report a “Maximum number of simultaneously transmitted SRS ports across all SRS resource sets used for STxMP” equal to four.
Maximum number of supported SRS ports per SRS resource per SRS resource set for STxMP operation. This could be useful for example to indicate if the UE has UE panels with four TX ports (which would mean that the UE can be configured with up to four SRS ports per SRS resource per SRS resource set for STxMP), or UE panels with two TX ports (which would mean that the UE can be configured with up to two SRS ports per SRS resource per SRS resource set for STxMP).
Maximum number of layers per SRS resource set or one maximum number of layers applicable to all SRS resource sets for STxMP operation (that is different from max rank in legacy specification which is applicable to for sTRP/Rel-17 mTRP repetition).
A list of maximum number of supported SRS ports per SRS resource per SRS resource set for STxMP operation, where different entries of the list corresponds to different UE panels/or types of UE panels (for example, the UE might report a list with entries 2 and 4, which then would mean that the UE supports one (or more) SRS resource set with up to four SRS ports per SRS resource (which e.g. could correspond to a UE panel with four TX ports) and one (or more) SRS resource set with up to two SRS ports per SRS resource (which e.g. could correspond to a UE panel with two TX ports)).
Indication of coherence capability, where the coherence capability depends on the number of SRS ports that is configured per SRS resource per SRS resource set, E.g., the UE might report fully coherent capability for two SRS ports per SRS resource per SRS resource set, and non-coherent capability for four SRS ports per SRS resource per SRS resource set. In this case, if the UE is configured with 4 SRS ports per SRS resource for an SRS resource set, the UE can only be indicated with non-coherent precoders during STxMP operation associated with that SRS resource set and in case the UE is configured with 2 SRS ports per SRS resource per SRS resource set, the UE can be indicated with fully coherent precoders (in addition to partially/non-coherent precoders according to Rel-15 rules).

Please note that one or more bullets of the list above of UE capability information related to STxMP could be indicated in one of the following ways:
Either jointly for both “SDM/sTRP operation” (i.e., where the UE is configured for SDM STxMP operation and NW can use “SRS resource set indicator” field in DCI to indicate SDM or sTRP transmission) and “SFN/sTRP operation” (i.e., where the UE is configured for SFN STxMP operation and NW can use “SRS resource set indicator” field in DCI to indicate SFN transmission or sTRP transmission).
Separately for “SDM/sTRP operation” and “SFN/sTRP operation”.
Only for “SDM/sTRP operation”.
Only for “SFN/sTRP operation”.

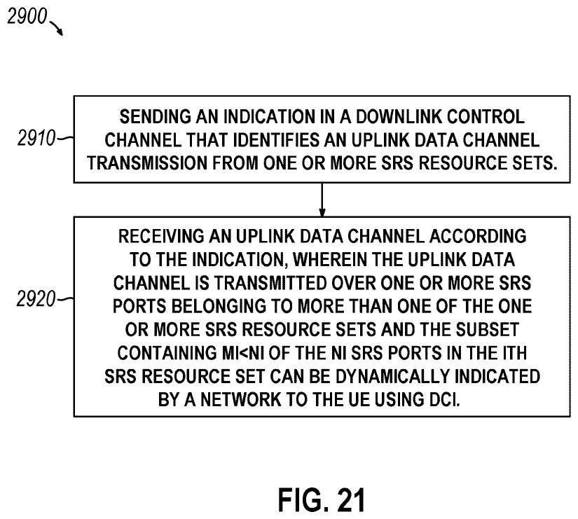

Another possible method embodiment under the present disclosure is shown in FIG. 21. Method 2900 comprises a method performed by a network node for configuring a UE for precoding of data channel and/or sounding of UE panels. Step 2910 is sending an indication in a downlink control channel that identifies an uplink data channel transmission from one or more SRS resource sets. Step 2920 is receiving an uplink data channel according to the indication. In some embodiments the uplink data channel is characterized in that the uplink data channel is transmitted over a subset of SRS ports belonging to one or more of the SRS resource sets and wherein the subset is either all of the Ni SRS ports of one SRS resource set, if a single SRS resource set is indicated, or includes at most Mi<Ni of the SRS ports from the ith SRS resource set, if, multiple SRS resource sets are indicated. Method 2900 can comprise multiple variations and embodiments and/or additional and/or alternative steps.

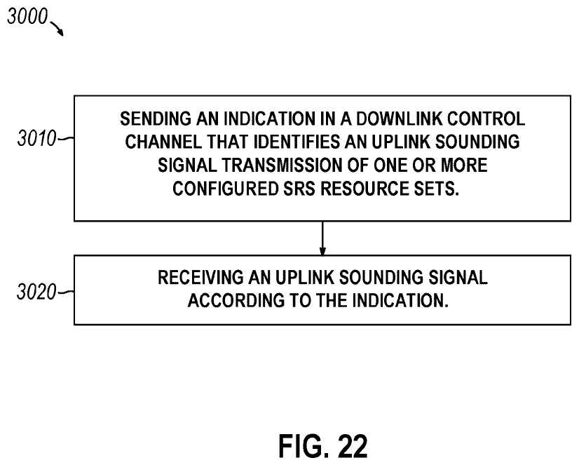

Another possible method embodiment under the present disclosure is shown in FIG. 22. Method 3100 comprises a method performed by a network node for configuring or communicating a UE for precoding of data channel and/or sounding of UE panels. Step 3110 is sending an indication in a downlink control channel that identifies an uplink sounding signal transmission of one or more configured SRS resource sets. Step 3120 is receiving an uplink sounding signal according to the indication. Method 3100 can comprise multiple variations and embodiments and/or additional and/or alternative steps.

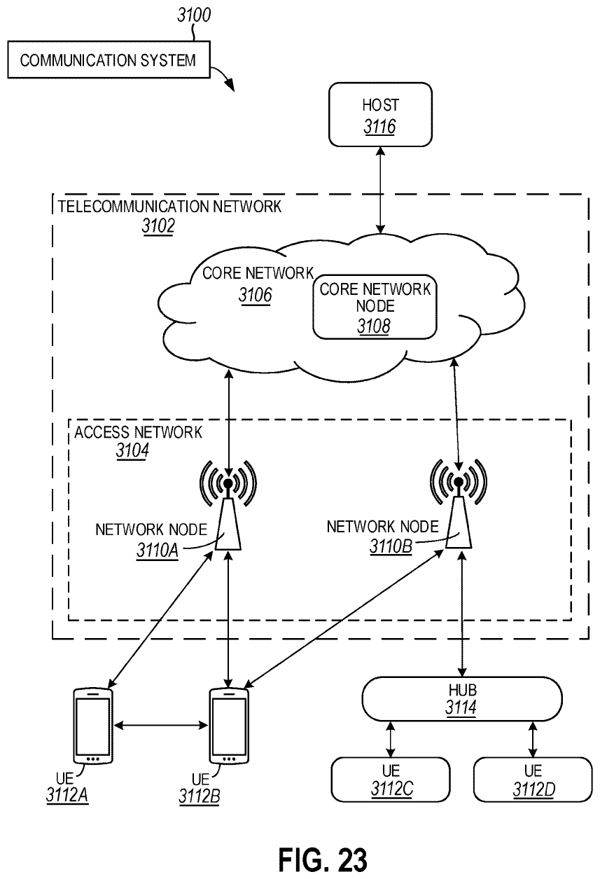

FIG. 23 shows an example of a communication system 2100 in accordance with some embodiments. In the example, the communication system 2100 includes a telecommunication network 2102 that includes an access network 2104, such as a RAN, and a core network 2106, which includes one or more core network nodes 2108. The access network 2104 includes one or more access network nodes, such as network nodes 2110a and 2110b (one or more of which may be generally referred to as network nodes 2110), or any other similar 3rd Generation Partnership Project (3GPP) access node or non-3GPP access point. The network nodes 2110 facilitate direct or indirect connection of UE, such as by connecting UEs 2112a, 2112b, 2112c, and 2112d (one or more of which may be generally referred to as UEs 2112) to the core network 2106 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 1100 may include any number of wired or wireless networks, network nodes, UEs, and/or any other components or systems that may facilitate or participate in the communication of data and/or signals whether via wired or wireless connections. The communication system 2100 may include and/or interface with any type of communication, telecommunication, data, cellular, radio network, and/or other similar type of system.

The UEs 2112 may be any of a wide variety of communication devices, including wireless devices arranged, configured, and/or operable to communicate wirelessly with the network nodes 2110 and other communication devices. Similarly, the network nodes 2110 are arranged, capable, configured, and/or operable to communicate directly or indirectly with the UEs 2112 and/or with other network nodes or equipment in the telecommunication network 2102 to enable and/or provide network access, such as wireless network access, and/or to perform other functions, such as administration in the telecommunication network 2102.

In the depicted example, the core network 2106 connects the network nodes 2110 to one or more hosts, such as host 2116. These connections may be direct or indirect via one or more intermediary networks or devices. In other examples, network nodes may be directly coupled to hosts. The core network 2106 includes one more core network nodes (e.g., core network node 2108) that are structured with hardware and software components. Features of these components may be substantially similar to those described with respect to the UEs, network nodes, and/or hosts, such that the descriptions thereof are generally applicable to the corresponding components of the core network node 2108. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 2116 may be under the ownership or control of a service provider other than an operator or provider of the access network 2104 and/or the telecommunication network 2102, and may be operated by the service provider or on behalf of the service provider. The host 2116 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 2100 of FIG. 23 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 2102 is a cellular network that implements 3GPP standardized features. Accordingly, the telecommunications network 2102 may support network slicing to provide different logical networks to different devices that are connected to the telecommunication network 2102. For example, the telecommunications network 2102 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 2112 are configured to transmit and/or receive information without direct human interaction. For instance, a UE may be designed to transmit information to the access network 2104 on a predetermined schedule, when triggered by an internal or external event, or in response to requests from the access network 2104. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, the hub 2114 communicates with the access network 2104 to facilitate indirect communication between one or more UEs (e.g., UE 2112c and/or 2112d) and network nodes (e.g., network node 2110b). In some examples, the hub 2114 may be a controller, router, content source and analytics, or any of the other communication devices described herein regarding UEs. For example, the hub 2114 may be a broadband router enabling access to the core network 2106 for the UEs. As another example, the hub 2114 may be a controller that sends commands or instructions to one or more actuators in the UEs. Commands or instructions may be received from the UEs, network nodes 2110, or by executable code, script, process, or other instructions in the hub 2114. As another example, the hub 2114 may be a data collector that acts as temporary storage for UE data and, in some embodiments, may perform analysis or other processing of the data. As another example, the hub 2114 may be a content source. For example, for a UE that is a VR headset, display, loudspeaker or other media delivery device, the hub 2114 may retrieve VR assets, video, audio, or other media or data related to sensory information via a network node, which the hub 2114 then provides to the UE either directly, after performing local processing, and/or after adding additional local content. In still another example, the hub 2114 acts as a proxy server or orchestrator for the UEs, in particular in if one or more of the UEs are low energy IoT devices.

The hub 2114 may have a constant/persistent or intermittent connection to the network node 2110b. The hub 2114 may also allow for a different communication scheme and/or schedule between the hub 2114 and UEs (e.g., UE 2112c and/or 2112d), and between the hub 2114 and the core network 2106. In other examples, the hub 2114 is connected to the core network 2106 and/or one or more UEs via a wired connection. Moreover, the hub 2114 may be configured to connect to an M2M service provider over the access network 1104 and/or to another UE over a direct connection. In some scenarios, UEs may establish a wireless connection with the network nodes 2110 while still connected via the hub 2114 via a wired or wireless connection. In some embodiments, the hub 2114 may be a dedicated hub—that is, a hub whose primary function is to route communications to/from the UEs from/to the network node 2110b. In other embodiments, the hub 2114 may be a non-dedicated hub—that is, a device which is capable of operating to route communications between the UEs and network node 2110b, but which is additionally capable of operating as a communication start and/or end point for certain data channels.

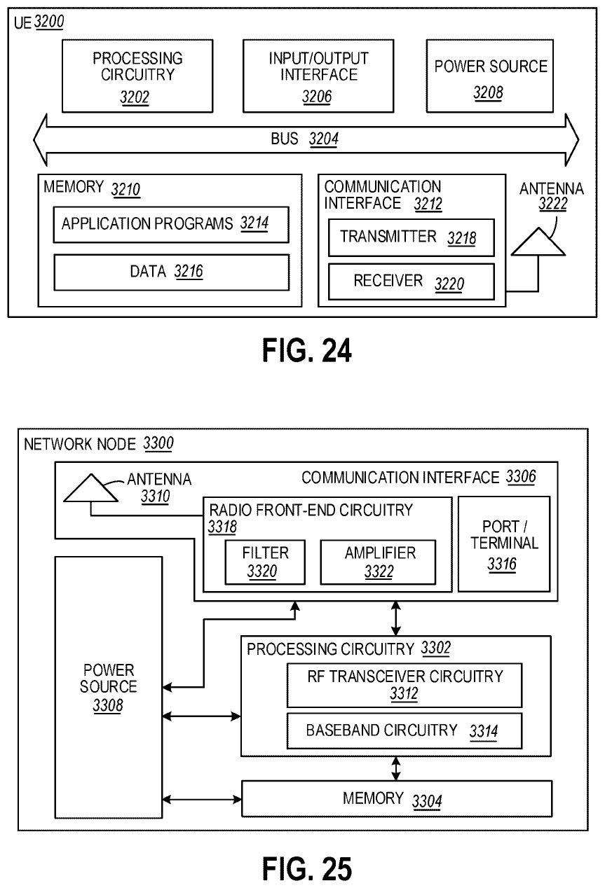

FIG. 24 shows a UE 2200 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VoIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

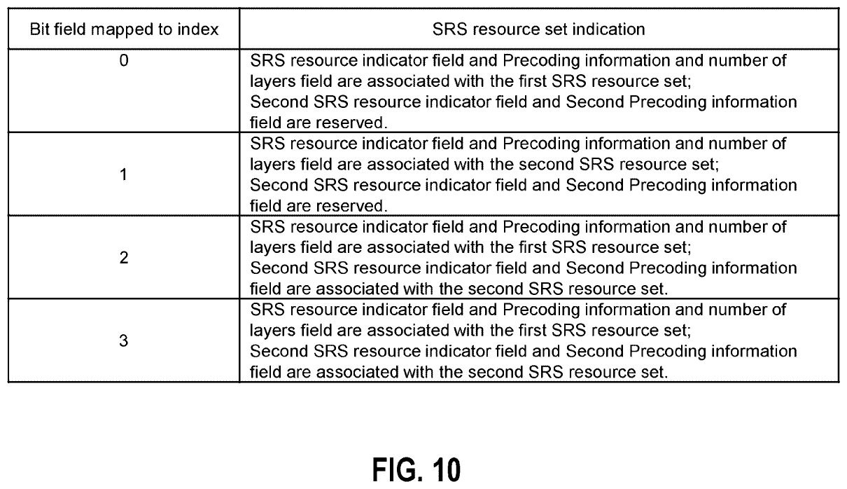

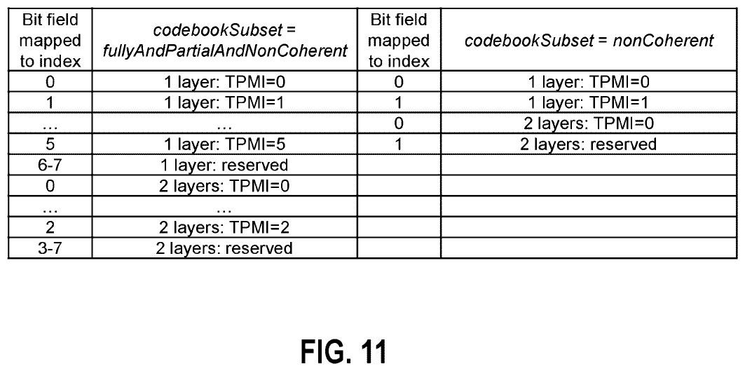

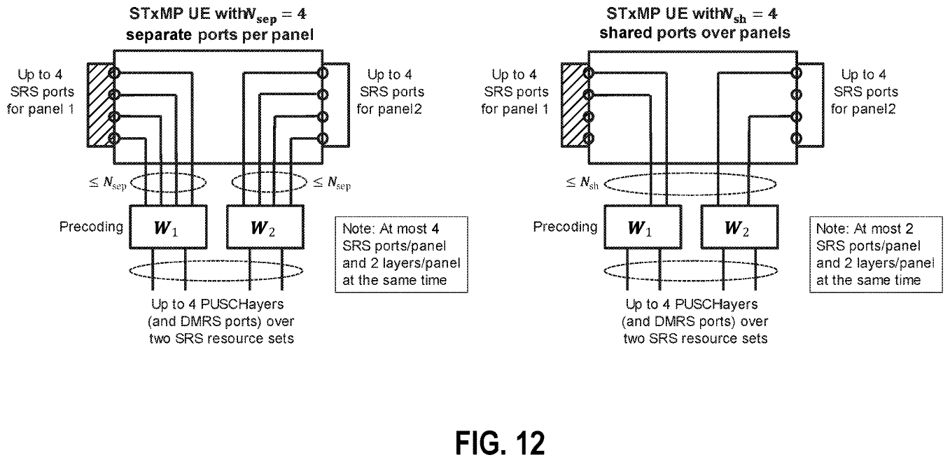

The UE 2200 includes processing circuitry 2202 that is operatively coupled via a bus 2204 to an input/output interface 2206, a power source 2208, a memory 2210, a communication interface 2212, and/or any other component, or any combination thereof. Certain UEs may utilize all or a subset of the components shown in FIG. 10. The level of integration between the components may vary from one UE to another UE. Further, certain UEs may contain multiple instances of a component, such as multiple processors, memories, transceivers, transmitters, receivers, etc.

The processing circuitry 2202 is configured to process instructions and data and may be configured to implement any sequential state machine operative to execute instructions stored as machine-readable computer programs in the memory 2210. The processing circuitry 2202 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 2202 may include multiple central processing units (CPUs).

In the example, the input/output interface 2206 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 2200. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 2208 is structured as a battery or battery pack. Other types of power sources, such as an external power source (e.g., an electricity outlet), photovoltaic device, or power cell, may be used. The power source 2208 may further include power circuitry for delivering power from the power source 2208 itself, and/or an external power source, to the various parts of the UE 2200 via input circuitry or an interface such as an electrical power cable. Delivering power may be, for example, for charging of the power source 2208. Power circuitry may perform any formatting, converting, or other modification to the power from the power source 2208 to make the power suitable for the respective components of the UE 2200 to which power is supplied.

The memory 2210 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 2210 includes one or more application programs 2214, such as an operating system, web browser application, a widget, gadget engine, or other application, and corresponding data 2216. The memory 2210 may store, for use by the UE 2200, any of a variety of various operating systems or combinations of operating systems.

The memory 2210 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 2210 may allow the UE 2200 to access instructions, application programs and the like, stored on transitory or non-transitory memory media, to off-load data, or to upload data. An article of manufacture, such as one utilizing a communication system may be tangibly embodied as or in the memory 2210, which may be or comprise a device-readable storage medium.

The processing circuitry 2202 may be configured to communicate with an access network or other network using the communication interface 2212. The communication interface 2212 may comprise one or more communication subsystems and may include or be communicatively coupled to an antenna 2222. The communication interface 2212 may include one or more transceivers used to communicate, such as by communicating with one or more remote transceivers of another device capable of wireless communication (e.g., another UE or a network node in an access network). Each transceiver may include a transmitter 2218 and/or a receiver 2220 appropriate to provide network communications (e.g., optical, electrical, frequency allocations, and so forth). Moreover, the transmitter 2218 and receiver 2220 may be coupled to one or more antennas (e.g., antenna 2222) and may share circuit components, software or firmware, or alternatively be implemented separately.

In the illustrated embodiment, communication functions of the communication interface 2212 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 2212, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 2200 shown in FIG. 10.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 25 shows a network node 3300 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 3300 includes a processing circuitry 3302, a memory 3304, a communication interface 3306, and a power source 3308. The network node 3300 may be composed of multiple physically separate components (e.g., a NodeB component and a RNC component, or a BTS component and a BSC component, etc.), which may each have their own respective components. In certain scenarios in which the network node 3300 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 1300 may be configured to support multiple radio access technologies (RATs). In such embodiments, some components may be duplicated (e.g., separate memory 3304 for different RATs) and some components may be reused (e.g., a same antenna 3310 may be shared by different RATs). The network node 3300 may also include multiple sets of the various illustrated components for different wireless technologies integrated into network node 1300, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 1300.

The processing circuitry 3302 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 3300 components, such as the memory 3304, to provide network node 3300 functionality.

In some embodiments, the processing circuitry 3302 includes a system on a chip (SOC). In some embodiments, the processing circuitry 3302 includes one or more of radio frequency (RF) transceiver circuitry 3312 and baseband processing circuitry 3314. In some embodiments, the radio frequency (RF) transceiver circuitry 3312 and the baseband processing circuitry 3314 may be on separate chips (or sets of chips), boards, or units, such as radio units and digital units. In alternative embodiments, part or all of RF transceiver circuitry 3312 and baseband processing circuitry 3314 may be on the same chip or set of chips, boards, or units.

The memory 3304 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 3302. The memory 3304 may store any suitable instructions, data, or information, including a computer program, software, an application including one or more of logic, rules, code, tables, and/or other instructions capable of being executed by the processing circuitry 3302 and utilized by the network node 3300. The memory 3304 may be used to store any calculations made by the processing circuitry 3302 and/or any data received via the communication interface 3306. In some embodiments, the processing circuitry 3302 and memory 3304 is integrated.

The communication interface 3306 is used in wired or wireless communication of signaling and/or data between a network node, access network, and/or UE. As illustrated, the communication interface 3306 comprises port(s)/terminal(s) 3316 to send and receive data, for example to and from a network over a wired connection. The communication interface 3306 also includes radio front-end circuitry 3318 that may be coupled to, or in certain embodiments a part of, the antenna 3310. Radio front-end circuitry 3318 comprises filters 3320 and amplifiers 3322. The radio front-end circuitry 3318 may be connected to an antenna 3310 and processing circuitry 3302. The radio front-end circuitry may be configured to condition signals communicated between antenna 3310 and processing circuitry 3302. The radio front-end circuitry 3318 may receive digital data that is to be sent out to other network nodes or UEs via a wireless connection. The radio front-end circuitry 3318 may convert the digital data into a radio signal having the appropriate channel and bandwidth parameters using a combination of filters 3320 and/or amplifiers 3322. The radio signal may then be transmitted via the antenna 3310. Similarly, when receiving data, the antenna 3310 may collect radio signals which are then converted into digital data by the radio front-end circuitry 3318. The digital data may be passed to the processing circuitry 3302. In other embodiments, the communication interface may comprise different components and/or different combinations of components.

In certain alternative embodiments, the network node 3300 does not include separate radio front-end circuitry 3318, instead, the processing circuitry 3302 includes radio front-end circuitry and is connected to the antenna 3310. Similarly, in some embodiments, all or some of the RF transceiver circuitry 3312 is part of the communication interface 3306. In still other embodiments, the communication interface 3306 includes one or more ports or terminals 3316, the radio front-end circuitry 3318, and the RF transceiver circuitry 3312, as part of a radio unit (not shown), and the communication interface 3306 communicates with the baseband processing circuitry 3314, which is part of a digital unit (not shown).

The antenna 3310 may include one or more antennas, or antenna arrays, configured to send and/or receive wireless signals. The antenna 3310 may be coupled to the radio front-end circuitry 3318 and may be any type of antenna capable of transmitting and receiving data and/or signals wirelessly. In certain embodiments, the antenna 3310 is separate from the network node 3300 and connectable to the network node 3300 through an interface or port.

The antenna 3310, communication interface 3306, and/or the processing circuitry 3302 may be configured to perform any receiving operations and/or certain obtaining operations described herein as being performed by the network node. Any information, data and/or signals may be received from a UE, another network node and/or any other network equipment. Similarly, the antenna 3310, the communication interface 3306, and/or the processing circuitry 3302 may be configured to perform any transmitting operations described herein as being performed by the network node. Any information, data and/or signals may be transmitted to a UE, another network node and/or any other network equipment.

The power source 3308 provides power to the various components of network node 3300 in a form suitable for the respective components (e.g., at a voltage and current level needed for each respective component). The power source 3308 may further comprise, or be coupled to, power management circuitry to supply the components of the network node 3300 with power for performing the functionality described herein. For example, the network node 3300 may be connectable to an external power source (e.g., the power grid, an electricity outlet) via an input circuitry or interface such as an electrical cable, whereby the external power source supplies power to power circuitry of the power source 3308. As a further example, the power source 3308 may comprise a source of power in the form of a battery or battery pack which is connected to, or integrated in, power circuitry. The battery may provide backup power should the external power source fail.

Embodiments of the network node 3300 may include additional components beyond those shown in FIG. 25 for providing certain aspects of the network node's functionality, including any of the functionality described herein and/or any functionality necessary to support the subject matter described herein. For example, the network node 3300 may include user interface equipment to allow input of information into the network node 3300 and to allow output of information from the network node 3300. This may allow a user to perform diagnostic, maintenance, repair, and other administrative functions for the network node 3300.

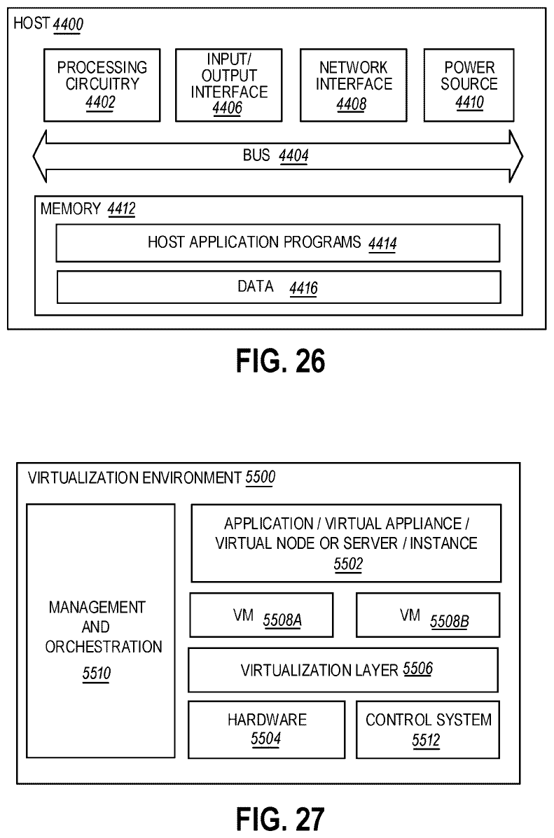

FIG. 26 is a block diagram of a host 4400, which may be an embodiment of the host 2116 of FIG. 23, in accordance with various aspects described herein. As used herein, the host 4400 may be or comprise various combinations hardware and/or software, including a standalone server, a blade server, a cloud-implemented server, a distributed server, a virtual machine, container, or processing resources in a server farm. The host 4400 may provide one or more services to one or more UEs.

The host 4400 includes processing circuitry 4402 that is operatively coupled via a bus 4404 to an input/output interface 4406, a network interface 4408, a power source 4410, and a memory 4412. Other components may be included in other embodiments. Features of these components may be substantially similar to those described with respect to the devices of previous figures, such as FIGS. 24 and 25, such that the descriptions thereof are generally applicable to the corresponding components of host 4400.

The memory 4412 may include one or more computer programs including one or more host application programs 4414 and data 4416, which may include user data, e.g., data generated by a UE for the host 4400 or data generated by the host 4400 for a UE. Embodiments of the host 4400 may utilize only a subset or all of the components shown. The host application programs 4414 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 4414 may also provide for user authentication and licensing checks and may periodically report health, routes, and content availability to a central node, such as a device in or on the edge of a core network. Accordingly, the host 4400 may select and/or indicate a different host for over-the-top services for a UE. The host application programs 4414 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. 27 is a block diagram illustrating a virtualization environment 5500 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 5500 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 5502 (which may alternatively be called software instances, virtual appliances, network functions, virtual nodes, virtual network functions, etc.) are run in the virtualization environment 5500 to implement some of the features, functions, and/or benefits of some of the embodiments disclosed herein.

Hardware 5504 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 5506 (also referred to as hypervisors or virtual machine monitors (VMMs)), provide VMs 5508a and 5508b (one or more of which may be generally referred to as VMs 5508), and/or perform any of the functions, features and/or benefits described in relation with some embodiments described herein. The virtualization layer 5506 may present a virtual operating platform that appears like networking hardware to the VMs 5508.

The VMs 5508 comprise virtual processing, virtual memory, virtual networking or interface and virtual storage, and may be run by a corresponding virtualization layer 5506. Different embodiments of the instance of a virtual appliance 5502 may be implemented on one or more of VMs 5508, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 5508 may be a software implementation of a physical machine that runs programs as if they were executing on a physical, non-virtualized machine. Each of the VMs 5508, and that part of hardware 5504 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 5508 on top of the hardware 5504 and corresponds to the application 5502.

Hardware 5504 may be implemented in a standalone network node with generic or specific components. Hardware 5504 may implement some functions via virtualization. Alternatively, hardware 5504 may be part of a larger cluster of hardware (e.g., such as in a data center or CPE) where many hardware nodes work together and are managed via management and orchestration 5510, which, among others, oversees lifecycle management of applications 5502. In some embodiments, hardware 5504 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 5512 which may alternatively be used for communication between hardware nodes and radio units.

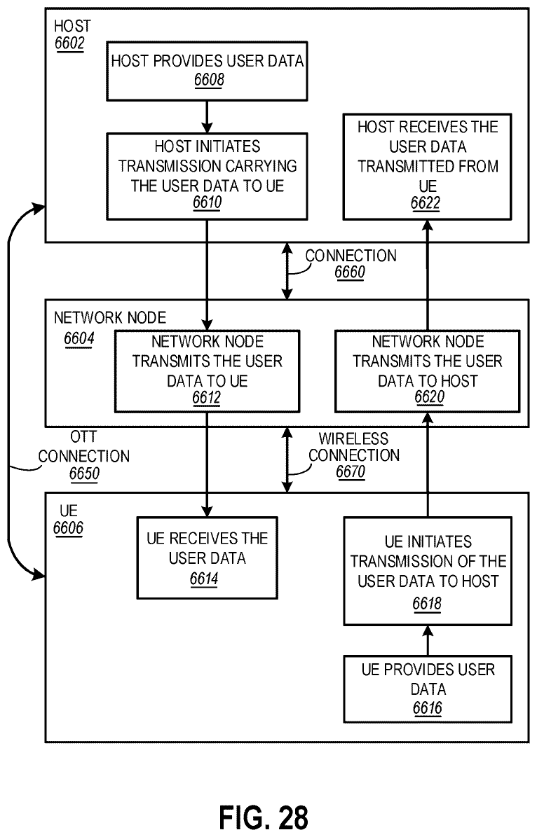

FIG. 28 shows a communication diagram of a host 6602 communicating via a network node 6604 with a UE 6606 over a partially wireless connection in accordance with some embodiments. Example implementations, in accordance with various embodiments, of the UE (such as a UE 2112a of FIG. 23 and/or UE 2200 of FIG. 24), network node (such as network node 2110a of FIG. 23 and/or network node 3300 of FIG. 25), and host (such as host 2116 of FIG. 23 and/or host 4400 of FIG. 26) discussed in the preceding paragraphs will now be described with reference to FIG. 28.

Like host 4400, embodiments of host 6602 include hardware, such as a communication interface, processing circuitry, and memory. The host 6602 also includes software, which is stored in or accessible by the host 6602 and executable by the processing circuitry. The software includes a host application that may be operable to provide a service to a remote user, such as the UE 6606 connecting via an over-the-top (OTT) connection 6650 extending between the UE 6606 and host 6602. In providing the service to the remote user, a host application may provide user data which is transmitted using the OTT connection 6650.

The network node 6604 includes hardware enabling it to communicate with the host 6602 and UE 6606. The connection 6660 may be direct or pass through a core network (like core network 2106 of FIG. 23) and/or one or more other intermediate networks, such as one or more public, private, or hosted networks. For example, an intermediate network may be a backbone network or the Internet.

The UE 6606 includes hardware and software, which is stored in or accessible by UE 6606 and executable by the UE's processing circuitry. The software includes a client application, such as a web browser or operator-specific “app” that may be operable to provide a service to a human or non-human user via UE 6606 with the support of the host 6602. In the host 6602, an executing host application may communicate with the executing client application via the OTT connection 6650 terminating at the UE 6606 and host 6602. In providing the service to the user, the UE's client application may receive request data from the host's host application and provide user data in response to the request data. The OTT connection 6650 may transfer both the request data and the user data. The UE's client application may interact with the user to generate the user data that it provides to the host application through the OTT connection 6650.

The OTT connection 6650 may extend via a connection 6660 between the host 6602 and the network node 6604 and via a wireless connection 6670 between the network node 6604 and the UE 6606 to provide the connection between the host 6602 and the UE 6606. The connection 6660 and wireless connection 6670, over which the OTT connection 6650 may be provided, have been drawn abstractly to illustrate the communication between the host 6602 and the UE 1606 via the network node 6604, without explicit reference to any intermediary devices and the precise routing of messages via these devices.

As an example of transmitting data via the OTT connection 6650, in step 6608, the host 6602 provides user data, which may be performed by executing a host application. In some embodiments, the user data is associated with a particular human user interacting with the UE 6606. In other embodiments, the user data is associated with a UE 6606 that shares data with the host 6602 without explicit human interaction. In step 6610, the host 6602 initiates a transmission carrying the user data towards the UE 6606. The host 6602 may initiate the transmission responsive to a request transmitted by the UE 6606. The request may be caused by human interaction with the UE 6606 or by operation of the client application executing on the UE 6606. The transmission may pass via the network node 6604, in accordance with the teachings of the embodiments described throughout this disclosure. Accordingly, in step 6612, the network node 6604 transmits to the UE 6606 the user data that was carried in the transmission that the host 6602 initiated, in accordance with the teachings of the embodiments described throughout this disclosure. In step 6614, the UE 6606 receives the user data carried in the transmission, which may be performed by a client application executed on the UE 6606 associated with the host application executed by the host 6602.

In some examples, the UE 6606 executes a client application which provides user data to the host 6602. The user data may be provided in reaction or response to the data received from the host 6602. Accordingly, in step 6616, the UE 6606 may provide user data, which may be performed by executing the client application. In providing the user data, the client application may further consider user input received from the user via an input/output interface of the UE 6606. Regardless of the specific manner in which the user data was provided, the UE 6606 initiates, in step 6618, transmission of the user data towards the host 6602 via the network node 6604. In step 6620, in accordance with the teachings of the embodiments described throughout this disclosure, the network node 6604 receives user data from the UE 6606 and initiates transmission of the received user data towards the host 6602. In step 6622, the host 6602 receives the user data carried in the transmission initiated by the UE 6606.

One or more of the various embodiments improve the performance of OTT services provided to the UE 6606 using the OTT connection 6650, in which the wireless connection 6670 forms the last segment. More precisely, the teachings of these embodiments may improve the data rate, latency, and/or power consumption and thereby provide benefits such as reduced user waiting time, relaxed restriction on file size, improved content resolution, better responsiveness, and/or extended battery lifetime.

In an example scenario, factory status information may be collected and analyzed by the host 6602. As another example, the host 6602 may process audio and video data which may have been retrieved from a UE for use in creating maps. As another example, the host 6602 may collect and analyze real-time data to assist in controlling vehicle congestion (e.g., controlling traffic lights). As another example, the host 6602 may store surveillance video uploaded by a UE. As another example, the host 6602 may store or control access to media content such as video, audio, VR or AR which it can broadcast, multicast or unicast to UEs. As other examples, the host 6602 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 6650 between the host 6602 and UE 6606, in response to variations in the measurement results. The measurement procedure and/or the network functionality for reconfiguring the OTT connection may be implemented in software and hardware of the host 6602 and/or UE 6606. In some embodiments, sensors (not shown) may be deployed in or in association with other devices through which the OTT connection 6650 passes; the sensors may participate in the measurement procedure by supplying values of the monitored quantities exemplified above, or supplying values of other physical quantities from which software may compute or estimate the monitored quantities. The reconfiguring of the OTT connection 6650 may include message format, retransmission settings, preferred routing etc.; the reconfiguring need not directly alter the operation of the network node 6604. Such procedures and functionalities may be known and practiced in the art. In certain embodiments, measurements may involve proprietary UE signaling that facilitates measurements of throughput, propagation times, latency and the like, by the host 6602. The measurements may be implemented in that software causes messages to be transmitted, in particular empty or ‘dummy’ messages, using the OTT connection 6650 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

It will be appreciated that computer systems are increasingly taking a wide variety of forms. In this description and in the claims, the terms “controller,” “computer system,” or “computing system” are defined broadly as including any device or system—or combination thereof—that includes at least one physical and tangible processor and a physical and tangible memory capable of having thereon computer-executable instructions that may be executed by a processor. By way of example, not limitation, the term “computer system” or “computing system,” as used herein is intended to include personal computers, desktop computers, laptop computers, tablets, hand-held devices (e.g., mobile telephones, PDAs, pagers), microprocessor-based or programmable consumer electronics, minicomputers, mainframe computers, multi-processor systems, network PCs, distributed computing systems, datacenters, message processors, routers, switches, and even devices that conventionally have not been considered a computing system, such as wearables (e.g., glasses).

The computing system also has thereon multiple structures often referred to as an “executable component.” For instance, the memory of a computing system can include an executable component. The term “executable component” is the name for a structure that is well understood to one of ordinary skill in the art in the field of computing as being a structure that can be software, hardware, or a combination thereof. For instance, when implemented in software, one of ordinary skill in the art would understand that the structure of an executable component may include software objects, routines, methods, and so forth, that may be executed by one or more processors on the computing system, whether such an executable component exists in the heap of a computing system, or whether the executable component exists on computer-readable storage media. The structure of the executable component exists on a computer-readable medium in such a form that it is operable, when executed by one or more processors of the computing system, to cause the computing system to perform one or more functions, such as the functions and methods described herein. Such a structure may be computer-readable directly by a processor—as is the case if the executable component were binary. Alternatively, the structure may be structured to be interpretable and/or compiled-whether in a single stage or in multiple stages-so as to generate such binary that is directly interpretable by a processor.

The terms “component,” “service,” “engine,” “module,” “control,” “generator,” or the like may also be used in this description. As used in this description and in this case, these terms-whether expressed with or without a modifying clause—are also intended to be synonymous with the term “executable component” and thus also have a structure that is well understood by those of ordinary skill in the art of computing.

In terms of computer implementation, a computer is generally understood to comprise one or more processors or one or more controllers, and the terms computer, processor, and controller may be employed interchangeably. When provided by a computer, processor, or controller, the functions may be provided by a single dedicated computer or processor or controller, by a single shared computer or processor or controller, or by a plurality of individual computers or processors or controllers, some of which may be shared or distributed. Moreover, the term “processor” or “controller” also refers to other hardware capable of performing such functions and/or executing software, such as the example hardware recited above.

In general, the various exemplary embodiments may be implemented in hardware or special purpose chips, circuits, software, logic, or any combination thereof. For example, some aspects may be implemented in hardware, while other aspects may be implemented in firmware or software which may be executed by a controller, microprocessor, or other computing device, although the disclosure is not limited thereto. While various aspects of the exemplary embodiments of this disclosure may be illustrated and described as block diagrams, flow charts, or using some other pictorial representation, it is well understood that these blocks, apparatus, systems, techniques, or methods described herein may be implemented in, as non-limiting examples, hardware, software, firmware, special purpose circuits or logic, general purpose hardware or controller or other computing devices, or some combination thereof.

While not all computing systems require a user interface, in some embodiments a computing system includes a user interface for use in communicating information from/to a user. The user interface may include output mechanisms as well as input mechanisms. The principles described herein are not limited to the precise output mechanisms or input mechanisms as such will depend on the nature of the device. However, output mechanisms might include, for instance, speakers, displays, tactile output, projections, holograms, and so forth. Examples of input mechanisms might include, for instance, microphones, touchscreens, projections, holograms, cameras, keyboards, stylus, mouse, or other pointer input, sensors of any type, and so forth.

### Abbreviations and Defined Terms

To assist in understanding the scope and content of this written description and the appended claims, a select few terms are defined directly below. Unless defined otherwise, all technical and scientific terms used herein have the same meaning as commonly understood by one of ordinary skill in the art to which the present disclosure pertains.

The terms “approximately,” “about,” and “substantially,” as used herein, represent an amount or condition close to the specific stated amount or condition that still performs a desired function or achieves a desired result. For example, the terms “approximately,” “about,” and “substantially” may refer to an amount or condition that deviates by less than 10%, or by less than 5%, or by less than 1%, or by less than 0.1%, or by less than 0.01% from a specifically stated amount or condition.

Various aspects of the present disclosure, including devices, systems, and methods may be illustrated with reference to one or more embodiments or implementations, which are exemplary in nature. As used herein, the term “exemplary” means “serving as an example, instance, or illustration,” and should not necessarily be construed as preferred or advantageous over other embodiments disclosed herein. In addition, reference to an “implementation” of the present disclosure or embodiments includes a specific reference to one or more embodiments thereof, and vice versa, and is intended to provide illustrative examples without limiting the scope of the present disclosure, which is indicated by the appended claims rather than by the present description.

As used in the specification, a word appearing in the singular encompasses its plural counterpart, and a word appearing in the plural encompasses its singular counterpart, unless implicitly or explicitly understood or stated otherwise. Thus, it will be noted that, as used in this specification and the appended claims, the singular forms “a,” “an” and “the” include plural referents unless the context clearly dictates otherwise. For example, reference to a singular referent (e.g., “a widget”) includes one, two, or more referents unless implicitly or explicitly understood or stated otherwise. Similarly, reference to a plurality of referents should be interpreted as comprising a single referent and/or a plurality of referents unless the content and/or context clearly dictate otherwise. For example, reference to referents in the plural form (e.g., “widgets”) does not necessarily require a plurality of such referents. Instead, it will be appreciated that independent of the inferred number of referents, one or more referents are contemplated herein unless stated otherwise.

References in the specification to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the associated listed terms.

It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

### CONCLUSION

The present disclosure includes any novel feature or combination of features disclosed herein either explicitly or any generalization thereof. Various modifications and adaptations to the foregoing exemplary embodiments of this disclosure may become apparent to those skilled in the relevant arts in view of the foregoing description, when read in conjunction with the accompanying drawings. However, any and all modifications will still fall within the scope of the non-limiting and exemplary embodiments of this disclosure.

It is understood that for any given component or embodiment described herein, any of the possible candidates or alternatives listed for that component may generally be used individually or in combination with one another, unless implicitly or explicitly understood or stated otherwise. Additionally, it will be understood that any list of such candidates or alternatives is merely illustrative, not limiting, unless implicitly or explicitly understood or stated otherwise.

In addition, unless otherwise indicated, numbers expressing quantities, constituents, distances, or other measurements used in the specification and claims are to be understood as being modified by the term “about,” as that term is defined herein. Accordingly, unless indicated to the contrary, the numerical parameters set forth in the specification and attached claims are approximations that may vary depending upon the desired properties sought to be obtained by the subject matter presented herein. At the very least, and not as an attempt to limit the application of the doctrine of equivalents to the scope of the claims, each numerical parameter should at least be construed in light of the number of reported significant digits and by applying ordinary rounding techniques. Notwithstanding that the numerical ranges and parameters setting forth the broad scope of the subject matter presented herein are approximations, the numerical values set forth in the specific examples are reported as precisely as possible. Any numerical values, however, inherently contain certain errors necessarily resulting from the standard deviation found in their respective testing measurements.

Any headings and subheadings used herein are for organizational purposes only and are not meant to be used to limit the scope of the description or the claims. The terms and expressions which have been employed herein are used as terms of description and not of limitation, and there is no intention in the use of such terms and expressions of excluding any equivalents of the features shown and described or portions thereof, but it is recognized that various modifications are possible within the scope of the present disclosure. Thus, it should be understood that although the present disclosure has been specifically disclosed in part by certain embodiments, and optional features, modification and variation of the concepts herein disclosed may be resorted to by those skilled in the art, and such modifications and variations are considered to be within the scope of this present description.

It will also be appreciated that systems, devices, products, kits, methods, and/or processes, according to certain embodiments of the present disclosure may include, incorporate, or otherwise comprise properties or features (e.g., components, members, elements, parts, and/or portions) described in other embodiments disclosed and/or described herein. Accordingly, the various features of certain embodiments can be compatible with, combined with, included in, and/or incorporated into other embodiments of the present disclosure. Thus, disclosure of certain features relative to a specific embodiment of the present disclosure should not be construed as limiting application or inclusion of said features to the specific embodiment. Rather, it will be appreciated that other embodiments can also include said features, members, elements, parts, and/or portions without necessarily departing from the scope of the present disclosure.

Moreover, unless a feature is described as requiring another feature in combination therewith, any feature herein may be combined with any other feature of a same or different embodiment disclosed herein. Furthermore, various well-known aspects of illustrative systems, methods, apparatus, and the like are not described herein in particular detail in order to avoid obscuring aspects of the example embodiments. Such aspects are, however, also contemplated herein.

It will be apparent to one of ordinary skill in the art that methods, devices, device elements, materials, procedures, and techniques other than those specifically described herein can be applied to the practice of the described embodiments as broadly disclosed herein without resort to undue experimentation. All art-known functional equivalents of methods, devices, device elements, materials, procedures, and techniques specifically described herein are intended to be encompassed by this present disclosure.

When a group of materials, compositions, components, or compounds is disclosed herein, it is understood that all individual members of those groups and all subgroups thereof are disclosed separately. When a Markush group or other grouping is used herein, all individual members of the group and all combinations and sub-combinations possible of the group are intended to be individually included in the disclosure.

The above-described embodiments are examples only. Alterations, modifications, and variations may be effected to the particular embodiments by those of skill in the art without departing from the scope of the description, which is defined solely by the appended claims.

1. A method performed by a user equipment, UE, for precoding of data channel and/or sounding of UE panels, the method comprising:
receiving an indication in a downlink control channel that identifies an uplink data channel transmission from one or more Sounding Reference Signal, SRS, resource sets; and
transmitting an uplink data channel according to the indication, wherein the uplink data channel is transmitted over a subset of SRS ports belonging to one or more of the SRS resource sets and wherein the subset is either all of the Ni SRS ports of one SRS resource set, if a single SRS resource set is indicated, or includes at most Mi<Ni of the SRS ports from the ith SRS resource set, if, multiple SRS resource sets are indicated.

2. The method of claim 1, further comprising indicating via UE capability signaling whether the one or more SRS ports are shared or separate between the one or more SRS resource sets.

3. The method of claim 1, wherein all SRS ports of at least one of the one or more SRS resource sets can be used for single transmission point, sTRP, communication.

4. The method of claim 1, wherein only a subset of SRS ports of at least one of the one or more SRS resource sets can be used for Simultaneous Transmission From Multiple Panels, STxMP.

5. The method of claim 1, wherein for codebook-based operation a subset of ports and/or precoders for each of the one or more SRS resource set is indicated by the network to the UE via a transmit precoder matrix indicator, TPMI, field in DCI and wherein a set A of valid precoder candidates in the TPMI field is a subset of the set B of valid precoder candidates for the case when UL data channel is transmitted over the one or more SRS ports belonging to one of the one or more SRS resource sets.

6. The method of claim 1, wherein A is a set of non-coherent, NC, precoders and B is the set of NC and partially coherent, PC, precoders for Nᵢ ports, respectively.

7. The method of claim 1, wherein the number of SRS ports and indicated rank for the i^{th} SRS resource set is four and one respectively, for which A is the set of NC+PC precoders.

8. The method of claim 1, wherein A is a set of NC precoders and B is the set of NC and PC and fully coherent, FC, precoders for Nᵢ ports, respectively.

9. The method of claim 1, wherein the number of SRS ports and indicated rank for the i^{th} SRS resource set is four and one respectively, for which A is the set of NC+PC precoders and for rank >1, A is the set of NC precoders.

10. The method of claim 1, wherein a subset of ports and/or precoders for each of the one or more SRS resource sets is indicated by the network to the UE for codebook-based operation via a transmit precoder matrix indicator, TPMI, field in DCI and wherein a codebook identifying a set of precoder candidates is different compared to a case when uplink data channel is transmitted over the one or more SRS ports belonging to one of the one or more SRS resource sets.

11. The method of claim 1, wherein the uplink data channel is transmitted over the one or more SRS ports belonging to more than one of the one or more SRS resource sets and the subset containing Mi<Ni of the Nᵢ SRS ports is fixed and known to both the UE and the network.

12-13. (canceled)

14. The method of claim 1, wherein for non-codebook beamforming, NCB, -based precoding the network indicates to the UE via an SRS Resource Indicator, SRI, field in DCI only Mi<Ni of the Nᵢ SRS resources in the i^{th} SRS resource set of the one or more resource sets.

15-18. (canceled)

19. The method of claim 1, wherein for codebook-based precoding wherein the UE indicates via UE capability signaling a first UE coherency capability for the case when the uplink data channel is transmitted over any SRS ports belonging to more than one of the one or more SRS resource sets and a second UE coherency capability for the case when the uplink data channel is transmitted over any SRS ports belonging to only one of the one or more SRS resource sets.

20. The method of claim 1, wherein the UE indicates whether more than one of the one or more SRS resource sets with usage ‘codebook’ and/or ‘nonCodebook’ can be transmitted at the same time.

21-43. (canceled)

44. A method performed by a network node for configuring a user equipment, UE, for precoding of data channel and/or sounding of UE panels, the method comprising:
sending an indication that identifies an uplink data channel transmission from one or more Sounding Reference Signal, SRS, resource sets; and
receiving an uplink data channel according to the indication, wherein the uplink data channel is transmitted over a subset of SRS ports belonging to one or more of the SRS resource sets and wherein the subset is either all of the Ni SRS ports of one SRS resource set, if a single SRS resource set is indicated, or includes at most Mi<Ni of the SRS ports from the ith SRS resource set, if, multiple SRS resource sets are indicated.

45. The method of claim 44, further comprising receiving an indication via UE capability signaling whether the one or more SRS ports are shared or separate between the one or more SRS resource sets.

46. The method of claim 44, wherein all SRS ports of at least one of the one or more SRS resource sets can be used for straight path communication, sTRP.

47. The method of claim 44, wherein only a subset of SRS ports of at least one of the one or more SRS resource sets can be used for Simultaneous Transmission From Multiple Panels, STxMP.

48-54. (canceled)

55. A user equipment, UE, for precoding of data channel and/or sounding of UE panels, comprising:
processing circuitry configured to perform the method of claim 1; and
power supply circuitry configured to supply power to the processing circuitry.

56. A network node for configuring a user equipment, UE, for precoding of data channel and/or sounding of UE panels, the network node comprising:
processing circuitry configured to perform the method of claim 44;
power supply circuitry configured to supply power to the processing circuitry.

57. (canceled)
